(19) United States
(12) Patent Application Publication
(10) Pub. No.: US 2026/0257338 A1
(43) Pub. Date: Sep. 3, 2026

(54) Grabber Tool

(71) Applicant: Peak Degrees Holdings LLC, Trophy Club, TX (US)

(72) Inventor: Christopher Pesek, Trophy Club, TX (US)

(21) Appl. No.: 19/654,700

(22) Filed: Apr. 22, 2026

Related U.S. Application Data
(63) Continuation-in-part of application No. 18/418,072, filed on Jan. 19, 2024.

(51) Int. Cl. B25J 1/04; A01K 77/00; B25G 1/10

(52) U.S. Cl. CPC B25J 1/04; A01K 77/00; B25G 1/102

(57) ABSTRACT

A grabber tool includes a handle mechanism, an elongate arm portion, a pincher mechanism, and an arm support portion. The handle mechanism includes an upper handle portion, a lower handle portion, and a trigger mechanism. The elongate arm portion extends distally from a first handle end of the upper handle portion. The pincher mechanism operably extends distally from the elongate arm portion and is operatively coupled to the trigger mechanism, which is operable to selectively close the pincher mechanism via the elongate arm portion. The arm support portion includes an array of radiused portions each of which extends in a respective and differing radiused portion plane. The arm support portion is configured to orient a forearm axis of a user's forearm toward the handle mechanism in parallel relation to the upper handle portion and counterbalance a load associated with the pincher mechanism.

### PRIOR HISTORY

This application is a Continuation-in-Part patent application claiming the benefit of U.S. patent application Ser. No. 18/418,072 filed in the United States Patent and Trademark Office on 19 Jan. 2024, the entire disclosure of which is hereby incorporated by reference.

### FIELD OF THE INVENTION

The present invention relates generally to tools for extending the reach of a user, and more particularly to a grabber tool for enabling a user to grab objects via an extended arm portion of the tool.

### BRIEF DESCRIPTION OF THE PRIOR ART

Grabber or reacher tools are known in the art and are generally known as reaching aids. Other commonly used descriptors for the devices or tools are grabber reacher aids, trash grabbers, trash picker tools, plier tools, and the like. In all known iterations of these types of devices, the load or weight of the target object is transferred into the handle mechanism so that the user can bring the object closer to his or her person to manually engage the reached/grabbed object. The object load or weight, however, is oftentimes stressful or may cause undue strain at the user's hand and peripheral anatomy causing discomfort or injury at the user's hand and peripheral anatomy.

The reader, for example, will consider U.S. Pat. No. 10,500,715, issued to Fleming ('715 Patent), which discloses a Foldable Reacher Grabber Tool. The '715 Patent describes an object-picking tool for picking objects from a distance includes an elongated arm and a gripping device. The elongated arm includes a distal arm and a proximal arm. Further the gripping device is provided at a distal end of the distal arm. The object-picking tool also includes a handle present on a proximal end of the proximal arm. Further, a controlling device is present on handle for controlling the gripping device. The object-picking tool further includes a folding and locking device having a button. The button, when pushed inside locks the distal arm and the proximal arm. The button when pushed back again or release unlock the distal arm and the proximal arm for folding.

Were a user to pick up an object via the distal object-gripping device, the load of the object would be transferred to the handle portion of the reacher or grabber tool, which may cause undue strain at the user's hand and wrist region causing discomfort or injury at the user's hand and peripheral anatomy. The grabber tool according to the presently disclosed subject matter attempts to alleviate load stress at the user's hand and wrist region by incorporating an arm support portion opposite the distal object-gripping end of the grabber tool so as to direct counter-balancing forces into a user's forearm region. The prior art further teaches arm support portions, however.

In this regard, the reader may consider U.S. Pat. No. 5,156,429 issued to Adams ('429 Patent), which discloses a Utility Handle. The '429 Patent describes a utility handle for lifting, lowering, supporting and maneuvering articles. The device comprises a generally S-shaped handle including a front portion that is engageable with the article and a handgrip member to be grasped by the hand of the user and further including a rear portion that is engageable with the forearm of the user. The utility handle substantially transfers the load of any attached article from the user's wrist to his forearm, and through the elbow joint, to the user's upper arm muscles to facilitate handling of the article.

Other prior art examples of hand tools having arm-engaging portions include U.S. Pat. No. 8,016,517 issued to Pardue ('517 Patent), which discloses Ergonomic Concrete Screed Handles and US Patent Application Publication No. 2010/0299855 authored by Megeath ('855 Publication), which discloses a Control Apparatus. The '517 Patent describes a paired set of handles attached to a board forming a concrete screed to minimize the strain on a person performing concrete finishing work allows for an ergonomic application of downward force applied to the lower end of the handles and application of an upward lifting force by the shape of the grip portion at the upper end of the handles, with the shape and contour of the handles requiring less strain and strength than current screed handles. The '855 Publication describes a control apparatus for a work object having a member with a substantially convoluted configuration such that it can be disposed in an operational position in contact with the work object in at least two points of contact to retain the control apparatus substantially in an operational position relative to the work object.

The prior art appears to be silent on a grabber tool having a similar arm support portion particularly designed to ease strain at the user's hand and wrist regions while further enabling the user to easily direct the distal object-grabbing end of the tool for the purpose of grabbing objects with extended reach thereby. These same principles are applicable to any number of load-bearing tools with distally extended portions as variously exemplified by fishing rods and fishnet ensembles. The prior art thus perceives a need for a grabber tool having an arm support portion operable to shift a tool load away from the relative more fragile hand and radiocarpal joint anatomy to the relatively more robust anchor structure provided by the user's forearm. The presently disclosed subject matter attempts to provide such a solution, as particularly incorporated into a reacher/grabber tool and a fishing tool as illustrated and summarized in more detail below.

### SUMMARY OF THE INVENTION

There is provided in accordance with an embodiment according to the presently disclosed subject matter a grabber tool for enabling a user to grab objects. In some embodiments, the grabber tool according to the presently disclosed subject matter comprises a handle mechanism, an elongate arm portion, a pincher mechanism, and an arm support portion. The handle mechanism is configured to be ergonomically received in a user's hand, and comprises an upper handle portion, a lower handle portion angled relative to the upper handle portion along a grip axis, and a trigger mechanism extending intermediate the upper handle portion and the lower handle portion configured to enable at least a portion of the user's hand to selectively direct a trigger portion thereof toward the lower handle portion.

The elongate arm portion extends distally from a first handle end of the upper handle portion along an arm axis. The upper handle portion extends along the arm axis, and the lower handle portion extends along a grip axis obliquely angled relative to the arm axis at a handle angle. The pincher mechanism operably extends distally from the elongate arm portion and is operatively coupled to the trigger mechanism. The trigger mechanism is operable to selectively close the pincher mechanism via the elongate arm portion.

The arm support portion has an array of radiused portions, including an arm-engaging radiused portion, a central radiused portion, and a handle-engaging radiused portion. The arm-engaging radiused portion, the central radiused portion, and the handle-engaging radiused portion each extend in a respective and differing radiused portion plane. The central radiused portion interconnects the arm-engaging radiused portion and the handle-engaging radiused portion. The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism. The arm support portion thereby counterbalances a load associated with the pincher mechanism.

In some embodiments, the lower handle portion comprises a female support mating portion therewithin, and the handle-engaging radiused portion terminates in a tool-engaging end with a male handle mating portion extending therefrom. The male handle mating portion is matble with the female support mating portion. In some embodiments, the female support mating portion is mated with the male handle mating portion such that an internal mating length of the male handle mating portion is greater than an external length of the male handle mating portion. In some embodiments, the lower handle portion comprises an internal array of rib elements spaced relative to one another along the internal mating length together configured to define the female support mating portion. The internal array of rib elements is configured to maintain axial alignment of the male handle mating portion relative to the female support mating portion when mated thereto.

In some embodiments, the male handle mating portion and the female support mating portion each comprise corresponding fastener-receiving apertures in spaced relation to one another along the internal mating length for receiving fasteners configured to fasten the male handle mating portion to the female support mating portion. In some embodiments, the arm-engaging radiused portion extends within a radiused arm portion plane or a first radiused portion plane obliquely angled relative to the arm axis such that the first radiused portion plane extends through a grip end of the upper handle portion at a junction thereof with the lower handle portion. In some embodiments, the radiused arm portion plane is obliquely angled intermediate the arm axis and the grip axis.

In some embodiments, the arm-engaging radiused portion comprises opposed linear first and second support segments extending from terminal ends of an arc length thereof configured to flank outer portions of the user's forearm equidistantly from the a user's forearm axis extending substantially parallel to the arm axis of the elongate arm portion. In some embodiments, the arm-engaging radiused portion comprising a first support segment extending along a first segment axis, a second support segment of equal length to the first support segment extending along a second segment axis obliquely angled relative to the first support segment, and a radiused support segment extending intermediate the first and second support segments. In some embodiments, the first and second support segments are equally angled relative to a median support plane extending through the male handle mating portion. The radiused support segment is configured to engage the user's forearm. In some embodiments, at least a portion of the arm-engaging radiused portion comprises a padded exterior surface for providing a padded interface intermediate the user's forearm and the arm-engaging radiused portion.

There is provided in accordance with another embodiment according to the presently disclosed subject matter a grabber tool for enabling a user to grab objects. The grabber tool comprises a handle mechanism, an elongate arm portion, a pincher mechanism, and an arm support portion. The handle mechanism comprises an upper handle portion, a lower handle portion, and a trigger mechanism. The elongate arm portion extends distally from a first handle end of the upper handle portion. The pincher mechanism operably extends distally from the elongate arm portion and is operatively coupled to the trigger mechanism. The trigger mechanism is operable to selectively close the pincher mechanism via the elongate arm portion.

The arm support portion comprises an arm-engaging radiused portion, a central radiused portion, and a handle-engaging radiused portion. The arm-engaging radiused portion, the central radiused portion, and the handle-engaging radiused portion each extend in a respective and differing radiused portion plane. The central radiused portion interconnects the arm-engaging radiused portion and the handle-engaging radiused portion. The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism. The arm support portion thereby counterbalances a load associated with the pincher mechanism.

In some embodiments, the lower handle portion comprises a female support mating portion therewithin. The handle-engaging radiused portion terminates in a tool-engaging end having a male handle mating portion extending therefrom. The male handle mating portion is matable with the female support mating portion. In some embodiments, the female support mating portion is mated with the male handle mating portion such that an internal mating length of the male handle mating portion is greater than an external length of the male handle mating portion.

In some embodiments, the lower handle portion comprises an internal array of rib elements spaced relative to one another along the internal mating length together being configured to define the female support mating portion. The internal array of rib elements is configured to maintain axial alignment of the male handle mating portion relative to the female support mating portion. In some embodiments, the male handle mating portion and the female support mating portion each comprise corresponding fastener-receiving apertures in spaced relation to one another along the internal mating length for receiving fasteners configured to fasten the male handle mating portion to the female support mating portion.

In some embodiments, the arm-engaging radiused portion extends within a radiused arm portion plane obliquely angled relative to the arm axis such that the radiused arm portion plane extends through a grip end of the upper handle portion at a junction thereof with the lower handle portion. The radiused arm portion plane is obliquely angled between the arm axis and the grip axis in some embodiments. In some embodiments, the arm-engaging radiused portion comprises opposed linear first and second support segments extending from terminal ends of an arc length thereof configured to flank outer portions of the user's forearm equidistantly from the forearm axis of a user's forearm extending in parallel relation to the arm axis of the elongate arm portion.

There is provided in accordance with another aspect of the presently disclosed subject matter a grabber tool for enabling a user to grab objects. The grabber tool comprises a handle mechanism further comprising an upper handle portion, a lower handle portion, and a trigger mechanism. The grabber tool further comprises a singular tubular member. The tubular member comprises an elongate arm portion, a through-handle portion and an arm support portion. The through-handle portion comprises a radiused handle portion, the arm support portion having an array of radiused portions, including an arm-engaging radiused portion, a central radiused portion, and a handle-engaging radiused portion.

The grabber tool further comprises a pincher mechanism operably extending distally from the elongate arm portion and being operatively coupled to the trigger mechanism. The trigger mechanism is operable to selectively close the pincher mechanism via the elongate arm portion. The through-handle portion extends through the handle mechanism such that the radiused handle portion extends through the upper handle portion and the lower handle portion integrally interconnecting a handle tube portion to a grip tube portion respectively extending through the upper handle portion and the lower handle portion. The arm-engaging radiused portion, the central radiused portion, and the handle-engaging radiused portion each extend in a respective and differing radiused portion plane such that the central radiused portion interconnects the arm-engaging radiused portion and the handle-engaging radiused portion.

The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism, the arm support portion thereby counterbalancing a load associated with the pincher mechanism.

In some embodiments, the arm-engaging radiused portion, the central radiused portion, and the handle-engaging radiused portion each extend through a respective and differing arc length. In some embodiments, the arm-engaging radiused portion extends through a first arc length, the central radiused portion extends through a second arc length, and the handle-engaging radiused portion extends through a third arc length. In some embodiments, the first arc length is greater than both the second and third arc lengths. In some embodiments, the third arc length is greater than the second arc length. In some embodiments, the arm-engaging radiused portion extends within a radiused arm portion plane or first radiused portion plane obliquely angled relative to the elongate arm portion such that the radiused arm portion plane extends through a grip end of the upper handle portion at a junction thereof with the lower handle portion. The radiused arm portion plane being obliquely angled between the elongate arm and the lower handle portion.

In some embodiments, the arm support portion is coextensive with or otherwise attachable to or in line with a load-bearing tool for counterbalancing a load associated with the load-bearing tool at a user's forearm. In some embodiments, the arm support portion according to the presently disclosed subject matter comprises a tubular body having at least three bends defining three planes and terminating in a tool-engaging end. Stated another way, the arm support portion comprises a tubular body having a convoluted S-type shape extending through three dimensions and comprises an upward slanting arm-engaging angled portion and a support-to-fulcrum angled portion, which portions extend in the intersecting first and third radiused portion planes.

A first of the two planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end, which tool-engaging end is coextensive with or attachable to or in line with a load-bearing tool, at least a weight of which is directed downwardly such that the arm-engaging angled portion is directed upwardly toward the user's forearm about a fulcrum point intermediate the tool-engaging end and the arm-engaging angled portion.

In some embodiments, the arm support portion comprises a handle portion at the fulcrum point. In some embodiments, the arm support portion comprises a fourth bend intermediate the fulcrum point and the tool-engaging end for orienting an axis of the tool-engaging end in parallel relation to the axis of the user's forearm. In some embodiments, the arm-engaging angled portion extends in a first radiused portion plane and the support-to-fulcrum extends in a third radiused portion plane, which first and third radiused portion planes are angled relative to one another. In some embodiments, the first radiused portion plane extends obliquely relative to the axis of the user's forearm such that the first radiused portion plane extends through an end of the handle portion.

In some embodiments, the arm-engaging angled portion comprises a first support segment, a second support segment and a radiused support segment extending intermediate the first and second support segments. The radiused support segment is configured for engaging a first portion of the user's forearm. In some embodiments, the first and second support segments flank outer portions of the user's forearm for further engaging outer portions of the user's forearm and increasing the support function of the arm-engaging angled portion. In some embodiments, the support-to-fulcrum angled portion comprises a first angle segment, a second angle segment and a radiused angle segment extending intermediate the first and second angle segments. In some embodiments, the support-to-fulcrum angled portion is connected to the arm-engaging angled support angled portion by way of a radiused central segment.

The arm support portion according to the presently disclosed subject matter is usable in combination a select load-bearing tool, which select load-bearing tool is selected from the group consisting of a grabber tool and a fishing tool, the latter of which may include a fishing rod or a fishnet tool. The grabber tool generally enables a user to grab objects in a manner akin to those briefly described above. As earlier described, similar tools are known in the art, and are commonly referred to as grabber tools or reacher tools. The distal ends of these types of grabber tools are generally outfitted with some type of pincher mechanism that is operable to pinch or grab an object so that the user may then reorient the tool and bring the grabbed object closer to the user's person without the need to bend, stand, reach, or climb upon secondary support structures to reach the targeted object.

As further introduced above, state-of-the-art tools of this type are typically configured such that the weight of the object(s) so grabbed are directed into the user's hand and radiocarpal joint by way of the elongated arm portion of the tools, thereby placing stress or strain upon the hand and/or radiocarpal joint causing discomfort or possible injury to the user in many instances. The grabber tool apparatus incorporating the arm support portion according to the presently disclosed subject matter helps shift moment away from the user's hand, the radiocarpal joint and peripheral anatomy toward the user's arm, which anatomy is better suited to provide static equilibrium with less strain at the user's hand and radiocarpal joint. The shift of the balancing force thereby decreases discomfort at the hand/joint during usage and improving overall stability and usage of the grabber tool, particularly for user's who have experienced previous injury to the anatomical areas or users who have experienced a decline in structural strength in these anatomical areas, for example, the elderly.

In certain embodiments, the presently disclosed subject matter may be said to essentially teach or disclose a grabber tool for enabling a user to grab objects. The grabber tool according to the presently disclosed subject matter comprises a handle mechanism, and elongate arm portion, a pincher mechanism, and an arm support portion. The handle mechanism is configured to be ergonomically received in a user's hand and comprises an upper handle portion, a lower handle portion angled relative to the upper handle portion, and a trigger mechanism.

In some embodiments, the elongate arm portion extends from a first handle end of the upper handle portion and comprises a proximal handle end and a distal pincher end. The pincher mechanism operably extends from the distal pincher end and is operatively coupled to the trigger mechanism via a force-transmitting mechanism as exemplified by a cable. The trigger mechanism is operable to selectively open and close the pincher mechanism via the force-transmitting mechanism. The arm support portion extends from the handle mechanism opposite the elongate arm portion for essentially providing a fulcrum point at the handle mechanism and is configured to engage a user's forearm for providing static equilibrium and countering a pincher mechanism load at the user's forearm and relieving stress at the user's hand.

In some embodiments, the elongate arm portion of the grabber tool may comprise or be outfitted with a pivot mechanism. The optional pivot mechanism enables the user to pivot the distal pincher end relative to the proximal handle end and collapse the grabber tool into a more compact or stowage configuration. In some embodiments, the pivot mechanism may comprise a loop member that extends outwardly from an outer surface thereof for enabling a user to support the grabber tool upon a hook member for storage. In some embodiments, the pivot mechanism may comprise opposed end-receiving portions extending from a centralized pivot mechanism, which end portions mate with distal and proximal arm portions of the elongate arm portion.

In some embodiments, the arm support portion may comprise a handle mating portion and the handle mechanism may comprise a support mating portion. The handle and support mating portions are matable in these embodiments for attaching the arm support portion to the handle mechanism. In some embodiments, the support mating portion is configured to receive the handle mating portion. In some embodiments, the handle and support mating portions each comprise at least one fastener-receiving aperture for receiving at least one fastener for fastening the arm support portion to the handle mechanism.

In some embodiments, the arm support portion is S-shaped in three dimensions and comprises an arm-engaging angled portion and a support-to-fulcrum angled portion. In some embodiments, the arm-engaging angled portion extends in a first radiused portion plane and the support-to-fulcrum portion extends in a third radiused plane, the first and third radiused portion planes being angled relative to one another about a radiused central segment extending in a second radiused portion plane. In some embodiments, the first radiused portion plane extends obliquely relative to the arm axis such that the first radiused portion plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

There is thus provided in accordance with another embodiment of the presently disclosed subject matter a grabber tool for enabling a user to grab objects. The grabber tool comprises a handle mechanism configured to be ergonomically received in a user's hand. The handle mechanism comprises a trigger mechanism configured to enable at least a portion of the user's hand to selectively direct at least a portion of the trigger mechanism in a first direction. The grabber tool further comprises an elongate arm portion. The elongate arm portion extends from the handle mechanism in a direction away from the first direction.

The grabber tool further comprises a pincher mechanism operably extending from the elongate arm portion. The pincher mechanism is operatively coupled to the trigger mechanism, which trigger mechanism is operable to selectively close the pincher mechanism. The grabber tool centrally further includes an arm support portion according to the presently disclosed subject matter. The arm support portion extends from the handle mechanism opposite the elongate arm portion for providing a fulcrum point at the handle mechanism and is configured to engage a user's forearm for providing static equilibrium and counterbalancing a grabbed object load at the user's forearm.

In some embodiments, the elongate arm portion may comprise a pivot mechanism, the pivot mechanism enables the user to pivot a distal arm portion relative to a proximal arm portion of the elongate arm portion to collapse the grabber tool into a more compact configuration. In some embodiments, the pivot mechanism may comprise a loop member that extends outwardly therefrom for enabling a user to support the grabber tool upon a hook member for storage.

In some embodiments, the arm support portion may comprise a handle mating portion and the handle mechanism may comprise a support mating portion. The handle and support mating portions are matable in these embodiments for attaching the arm support portion to the handle mechanism. In some embodiments, the support mating portion is configured to receive the handle mating portion. In some embodiments, the handle and support mating portions each comprise at least one fastener-receiving aperture for receiving at least one fastener for fastening the arm support portion to the handle mechanism.

In some embodiments, the arm support portion is S-shaped in three dimensions and comprises an arm-engaging angled portion and a support-to-fulcrum angled portion. In some embodiments, the arm-engaging angled portion extends in a first radiused portion plane and the support-to-fulcrum portion extends in a third radiused portion plane, the first and third radiused portion planes being angled relative to one another about a radiused central segment extending in a second radiused portion plane. In some embodiments, the first radiused portion plane extends obliquely relative to the arm axis such that the first radiused portion plane extends through a grip end of the upper handle portion. In some embodiments, the arm-engaging angled portion comprises a first support segment, a second support segment and a radiused support segment extending intermediate the first and second support segments, the radiused support segment being configured for engaging the user's forearm.

In some embodiments, the first and second support segments flank outer portions of the user's forearm for further engaging the user's forearm and increasing the support function of the arm-engaging angled portion. In some embodiments, the first and second support segments are angled 40 degrees with respect to one another. In some embodiments, at least a portion of the arm-engaging angled portion comprises a padded exterior surface for providing a padded interface intermediate the user's forearm and the arm-engaging angled portion for enhancing comfort at the user's forearm during use of the grabber tool. In some embodiments, the support-to-fulcrum angled portion comprises a first angle segment, a second angle segment and a radiused angle segment extending intermediate the first and second angle segments, the first and second angle segments being angled 30 degrees with respect to one another. In some embodiments, the support-to-fulcrum angled portion is connected to the arm support angled portion by way of a radiused central segment.

The exemplary fishing tool embodiments also incorporate the arm support portion according to the presently disclosed subject matter, which arm support portion comprises a tubular body having at least three bends defining two planes and terminating in a tool-engaging end coextensive with or connected to or in line with an elongate arm portion, the distal end of which is configured to bear a load as exemplified by a fish load. In some embodiments, the arm support portion comprises a tubular body having an S-shape in three dimensions and comprises an upward slanting arm-engaging angled portion and a support-to-fulcrum angled portion, the latter of which is coextensive with or connected to or in line with an elongate arm portion substantially as earlier described.

A first of the radiused portion planes comprises an upward slanting arm-engaging angled portion opposite the tool-engaging end. The arm-engaging angled portion comprises one of the bends disposed between a pair of support segments. The bends cooperate to orient an axis of a user's forearm toward the tool-engaging end and the elongate arm portion, which tool-engaging end is attachable to either a fishing rod or a fishnet, the weight of which, whether with or without a fish or other load is directed downwardly such that the arm-engaging angled portion is directed upwardly toward the user's forearm about a fulcrum point intermediate the tool-engaging end and the arm-engaging angled portion. In some embodiments, the arm support portion may further comprise a fourth bend intermediate the fulcrum point and the tool-engaging end for orienting an axis of the tool-engaging end and elongate arm portion in parallel relation to the axis of the user's forearm.

### BRIEF DESCRIPTION OF THE DRAWINGS

Other features and objectives of the presently disclosed subject matter will become more evident from a consideration of the following brief descriptions of patent drawings.

FIG. 1 is a top perspective view of the grabber tool with arm support portion according to the presently disclosed subject matter showing the grabber tool with arm support portion in an extended configuration.

FIG. 2 is an exploded top perspective view of the grabber tool with arm support portion according to the presently disclosed subject matter showing the grabber tool with arm support portion in an extended, exploded configuration.

FIG. 3 is a lateral side view of the grabber tool with arm support portion according to the presently disclosed subject matter showing the grabber tool with arm support portion in an extended configuration and in an object-grabbing condition of use.

FIG. 3A is a first sequential depiction of a pincher mechanism according to the presently disclosed subject matter before being triggered to pick up a relatively small object.

FIG. 3B is a second sequential depiction of the pincher mechanism otherwise shown in FIG. 3A pinching or grabbing the relatively small object.

FIG. 3C is a third sequential depiction of the pincher mechanism otherwise shown in FIGS. 3A and 3B picking up the grabbed relatively small object.

FIG. 3D is a combination perspective view and enlarged sectional view of a pincher mechanism according to the presently disclosed subject matter outfitted with a magnet at a grabber element as enlarged and sectioned from the pincher mechanism for magnetically attracting a set of ferromagnetic keys.

FIG. 4 is a top plan view of the grabber tool with arm support portion according to the presently disclosed subject matter showing the grabber tool with arm support portion in an extended configuration positioned adjacent a target object with object weight being directed into the page and a balancing force at the arm support portion being directed out of the page.

FIG. 5 is a bottom plan view of the grabber tool with arm support portion according to the presently disclosed subject matter showing the grabber tool with arm support portion in an extended configuration positioned adjacent the target object with object weight being directed out of the page and the balancing force at the arm support portion being directed into the page.

FIG. 6 is a top perspective view of the grabber tool with arm support portion according to the presently disclosed subject matter showing the grabber tool with arm support portion in an optional collapsed, stowage configuration.

FIG. 7 is a lateral side view of the grabber tool with arm support portion according to the presently disclosed subject matter showing the grabber tool with arm support portion in the optional collapsed, stowage configuration.

FIG. 8 is a top plan view of the grabber tool with arm support portion according to the presently disclosed subject matter showing the grabber tool with arm support portion in the optional collapsed, stowage configuration.

FIG. 9 is a proximal end view of the grabber tool with arm support portion according to the presently disclosed subject matter showing the grabber tool with arm support portion in the optional collapsed, stowage configuration.

FIG. 10 is an enlarged, bottom perspective view of a handle mechanism of the grabber tool with arm support portion according to the presently disclosed subject matter showing a trigger mechanism and arm support-mating structure thereof.

FIG. 11 is an enlarged, lateral side view of the handle mechanism of the grabber tool according to the presently disclosed subject matter.

FIG. 12 is an enlarged, distal end view of the handle mechanism of the grabber tool according to the presently disclosed subject matter.

FIG. 13 is a lateral side view of an elongate arm portion of the grabber tool according to the presently disclosed subject matter.

FIG. 14 is an exploded lateral side view of the elongate arm portion of the grabber tool according to the presently disclosed subject matter.

FIG. 15 is an enlarged distal end view of the elongate arm portion of the grabber tool according to the presently disclosed subject matter.

FIG. 16 is an enlarged lateral side view of a pincher mechanism of the grabber tool according to the presently disclosed subject matter.

FIG. 17A is an enlarged top plan view of the pincher mechanism of the grabber tool according to the presently disclosed subject matter depicting the pincher mechanism being operated to pinch or grab a generic object.

FIG. 17B is an enlarged top plan view of the pincher mechanism of the grabber tool according to the presently disclosed subject matter depicting the pincher mechanism being operated to release the generic object.

FIG. 17C is a perspective view of a pincher mechanism according to the presently disclosed subject matter outfitted with an object-hooking extension member extending from a grabber element for hooking objects outfitted with loop members.

FIG. 18 is a first top perspective view of the arm support portion usable in combination with the grabber tool according to the presently disclosed subject matter depicting a fragmentary user forearm in positioned placement atop the arm support portion to show relative placement of the user forearm relative to the arm support portion.

FIG. 18A is a lateral side view of a grabber tool according to the presently disclosed subject matter with an optional pivot mechanism installed on an elongate arm portion and showing a user holding the grabber tool.

FIG. 18B is a lateral side view of a grabber tool according to the presently disclosed subject matter with the optional pivot mechanism removed from the elongate arm portion and showing a user holding the grabber tool presented in side-by-side relation to FIG. 18A for ease of comparison.

FIG. 19 is a second top perspective view of the arm support portion usable in combination with the grabber tool according to the presently disclosed subject matter showing a distal support-to-fulcrum angled portion and a proximal arm-engaging angled portion thereof and depicting the angular relationship of a first support segment relative to a second support segment of the arm-engaging angled portion.

FIG. 20 is a distal end view of the arm support portion usable in combination with the grabber tool according to the presently disclosed subject matter.

FIG. 21 is a proximal end view of the arm support portion usable in combination with the grabber tool according to the presently disclosed subject matter.

FIG. 22 is a side view of the arm support portion of the grabber tool according to the presently disclosed subject matter depicting the angular relationship of the proximal arm-engaging angled portion relative to the support-to-fulcrum angled portion.

FIG. 23 is a side view of the arm support portion usable in combination with the grabber tool according to the presently disclosed subject matter depicting the angular relationship of the support-to-fulcrum angled portion relative to the arm-engaging angled portion.

FIG. 24 is a perspective view of the arm support portion usable in combination with the grabber tool according to the presently disclosed subject matter depicting the angular relationship of a first angle segment relative to a second angle segment of the support-to-fulcrum angled portion.

FIG. 25 is a bottom perspective view of the arm support portion usable in combination with the grabber tool according to the presently disclosed subject matter showing the support-to-fulcrum angled portion and the arm-engaging angled portion thereof.

FIG. 26 is a lateral side view of a modified handle mechanism attached to the arm support portion with a fragmentary elongate arm portion depicting a diagrammatic load at the distal end thereof and a balancing force being depicted at the arm support portion.

FIG. 27 is a top plan view of the modified handle mechanism attached to the arm support portion with the fragmentary elongate arm portion depicting a diagrammatic load at the distal end thereof directed into the page and the balancing force being depicted at the arm support portion being directed out of the page.

FIG. 28 is a lateral side view of a partial handle mechanism with a handle housing portion removed as attached to the arm support portion with a fragmentary elongate arm portion depicting a male handle mating portion of the arm support portion mated with a female support mating portion of the handle mechanism.

FIG. 29 is an enlarged fragmentary view of the handle mechanism otherwise shown in FIG. 28 enlarged to show in greater clarity an internal mating length of the male handle mating portion greater than an external length of the male handle mating portion at the lower mating portion end of the arm support portion.

FIG. 30 is an enlarged transverse cross-sectional view as sectioned through the lower handle portion of the handle mechanism to show the male handle mating portion mated with the female support mating portion of the handle mechanism.

FIG. 31 is a rear perspective view of a partial handle mechanism with a handle housing portion removed as attached to the arm support portion with a fragmentary elongate arm portion depicting a male handle mating portion of the arm support portion mated with a female support mating portion of the handle mechanism.

FIG. 32 is a front perspective view of a partial handle mechanism with a handle housing portion removed as attached to the arm support portion with a fragmentary elongate arm portion depicting a male handle mating portion of the arm support portion mated with a female support mating portion of the handle mechanism.

FIG. 33 is a top plan view of an arm-engaging radiused portion of the arm support portion showing a first arc length extending along a first central angle and a first arm support radius.

FIG. 34 is an outer edge view of the arm-engaging radiused portion of the arm support portion otherwise shown in FIG. 33 showing the arm-engaging radiused portion extending in a first radiused portion plane.

FIG. 35 is a plan view of a central radiused portion of the arm support portion showing a second arc length extending along a second central angle and a second arm support radius.

FIG. 36 is an outer edge view of the central radiused portion of the arm support portion otherwise shown in FIG. 35 showing the central radiused portion extending in a second radiused portion plane.

FIG. 37 is a plan view of a handle-engaging radiused portion of the arm support portion showing a third arc length extending along a third central angle and a third arm support radius.

FIG. 38 is an outer edge view of the handle-engaging radiused portion of the arm support portion otherwise shown in FIG. 37 showing the handle-engaging radiused portion extending in a third radiused portion plane.

FIG. 39 is a lateral side view of an alternative singular tubular member according to the presently disclosed subject matter comprising an elongate arm portion, a through-handle portion and an arm support portion.

FIG. 40 is an alternative handle mechanism as attached to the singular tubular member otherwise shown in FIG. 39 showing a fragmentary elongate arm portion external to the alternative handle mechanism and the a through-handle portion extending through the alternative handle mechanism and the arm support portion extending rearwardly from the alternative handle mechanism.

FIG. 41 is a first perspective view of the modified handle mechanism attached to the arm support portion with the fragmentary elongate arm portion depicting a generic fishing rod ensemble in line with the fragmentary elongate arm portion with a fish load at the distal end thereof and a balancing force being depicted at the arm support portion.

FIG. 42 is a second perspective view of the modified handle mechanism attached to the arm support portion with the fragmentary elongate arm portion depicting a generic fishnet ensemble in line with the fragmentary elongate arm portion with a net load at the distal end thereof and a balancing force being depicted at the arm support portion.

FIG. 43 is a top perspective view of a first fishnet tool shown in an extended configuration and outfitted with or connected to an arm support portion according to the presently disclosed subject matter.

FIG. 44 is a top perspective view of the first fishnet tool shown in a collapsed, stowage configuration and outfitted with or connected to an arm support portion according to the presently disclosed subject matter.

FIG. 45 is a first lateral side view of the first fishnet tool shown in an extended configuration and outfitted with or connected to an arm support portion according to the presently disclosed subject matter.

FIG. 46 is a second lateral side view of the first fishnet tool shown in an extended configuration and outfitted with or connected to an arm support portion according to the presently disclosed subject matter.

FIG. 47 is a top perspective view of a second fishnet tool shown in an extended configuration and outfitted with or connected to an arm support portion according to the presently disclosed subject matter.

FIG. 48 is a top perspective view of the second fishnet tool shown in a collapsed, stowage configuration and outfitted with or connected to an arm support portion according to the presently disclosed subject matter.

FIG. 49 is a first lateral side view of the second fishnet tool shown in an extended configuration and outfitted with or connected to an arm support portion according to the presently disclosed subject matter.

FIG. 50 is a second lateral side view of the second fishnet tool shown in an extended configuration and outfitted with or connected to an arm support portion according to the presently disclosed subject matter.

### DETAILED DESCRIPTION OF THE EMBODIMENTS

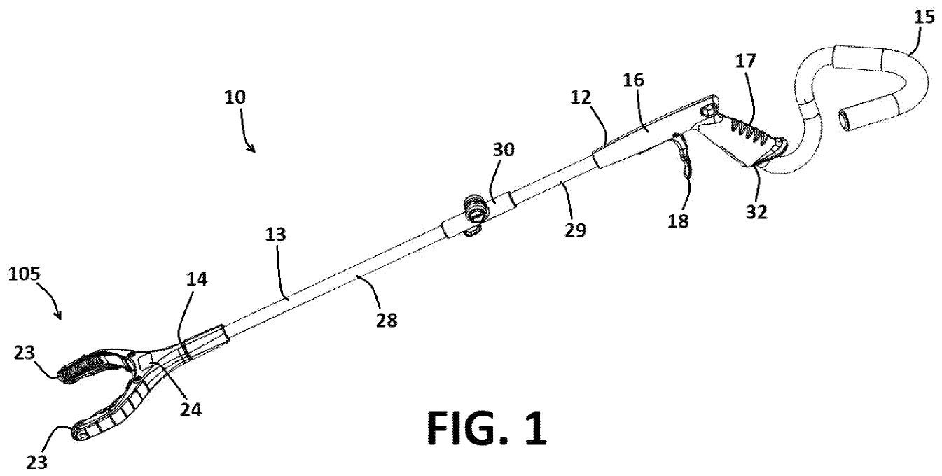

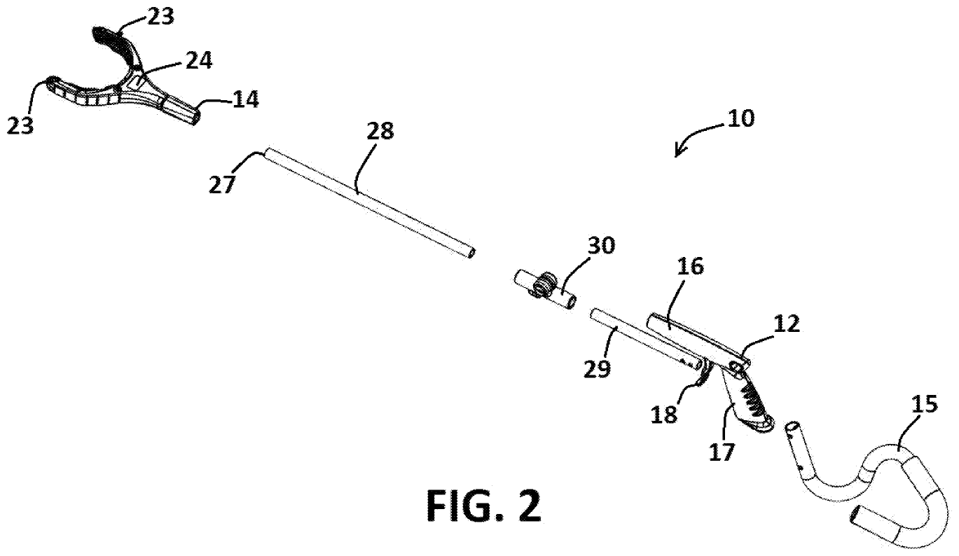

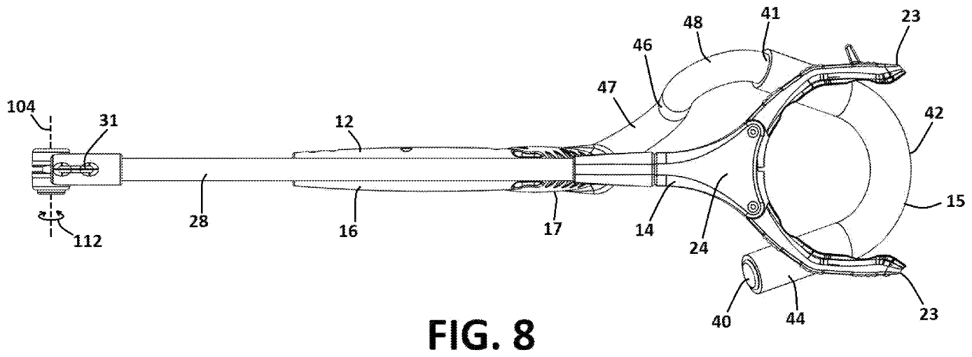

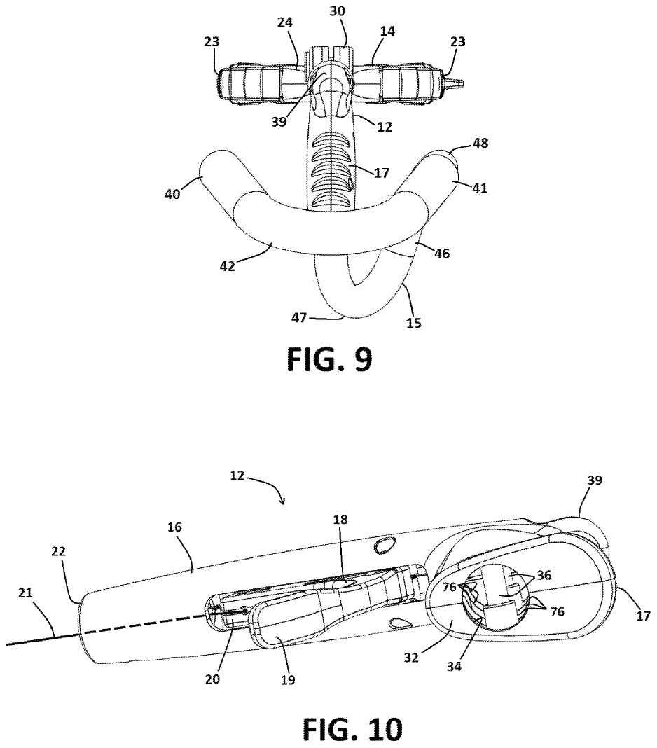

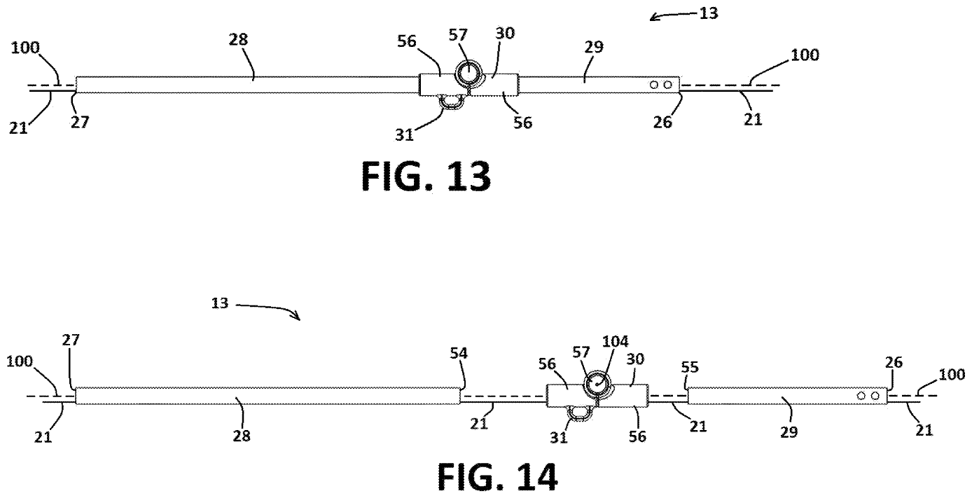

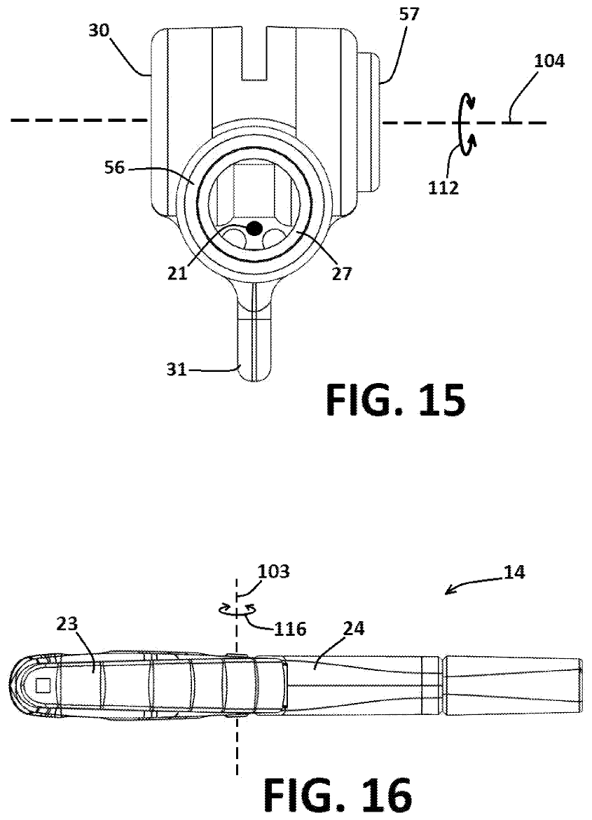

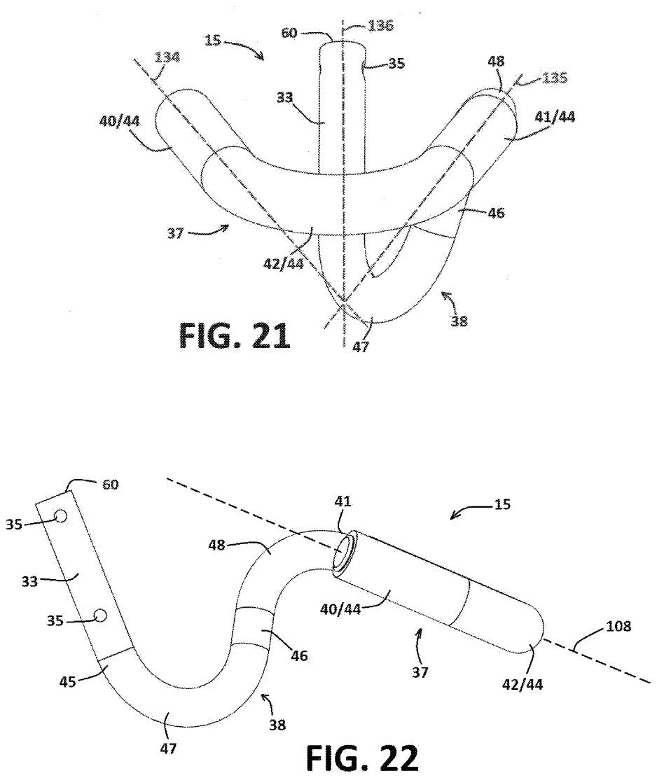

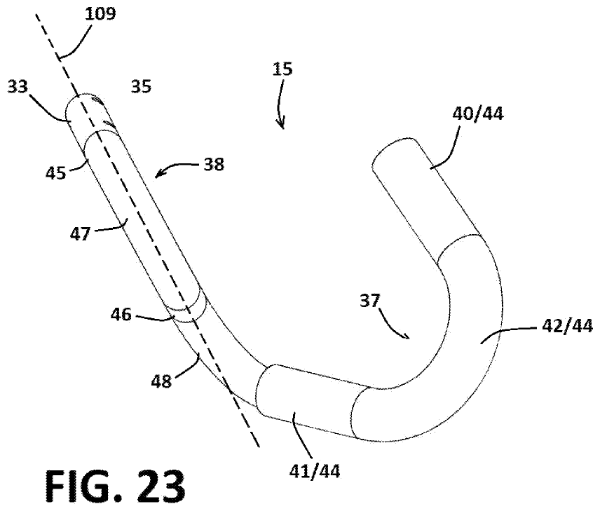

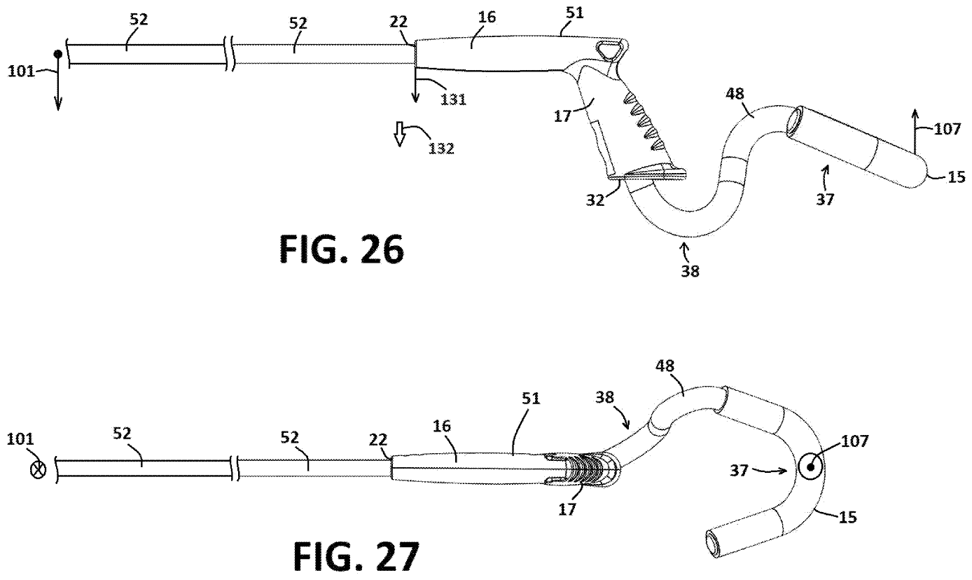

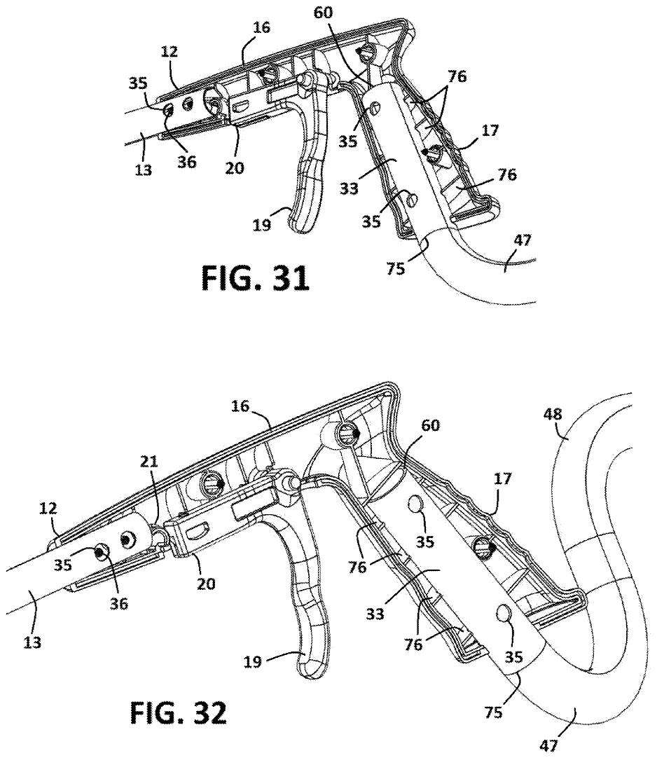

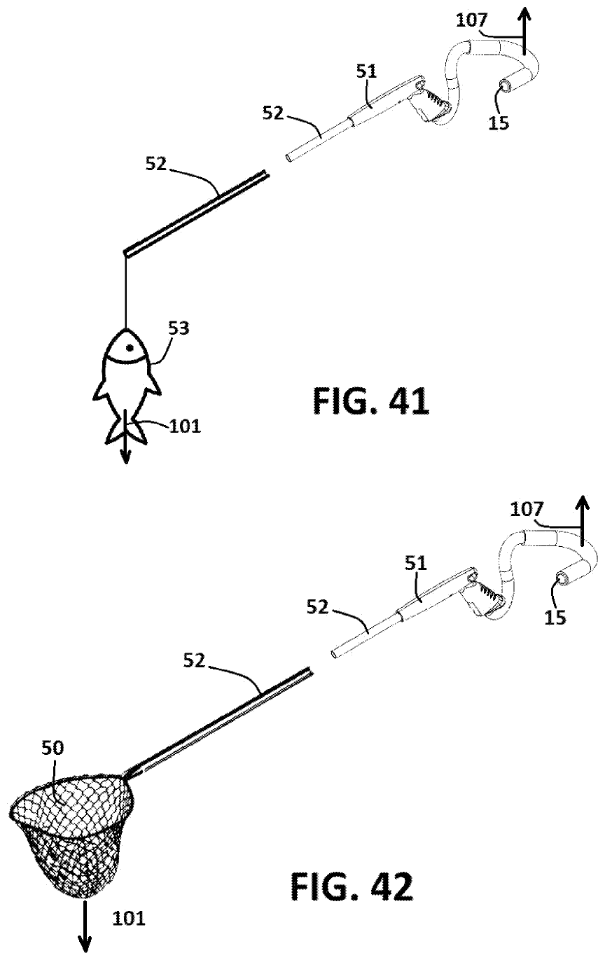

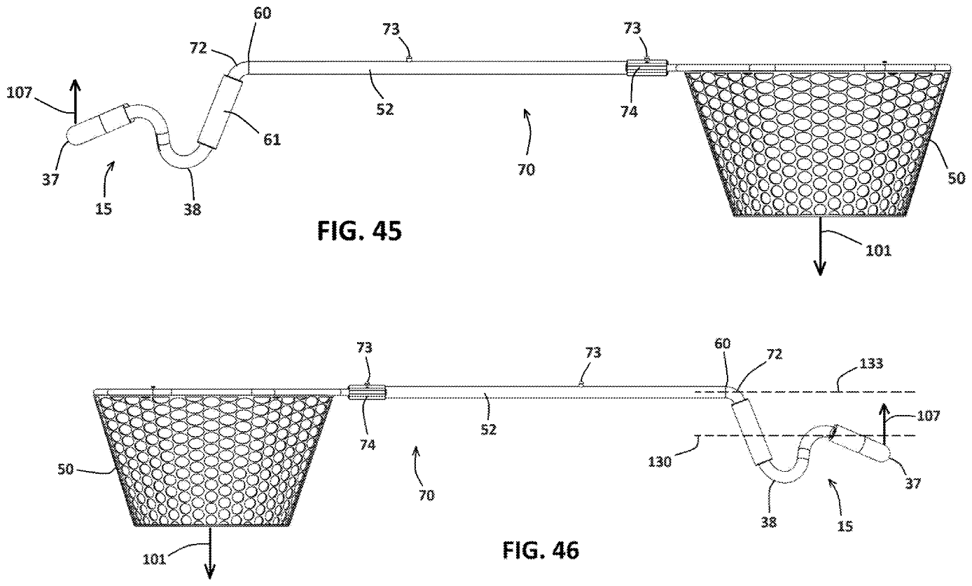

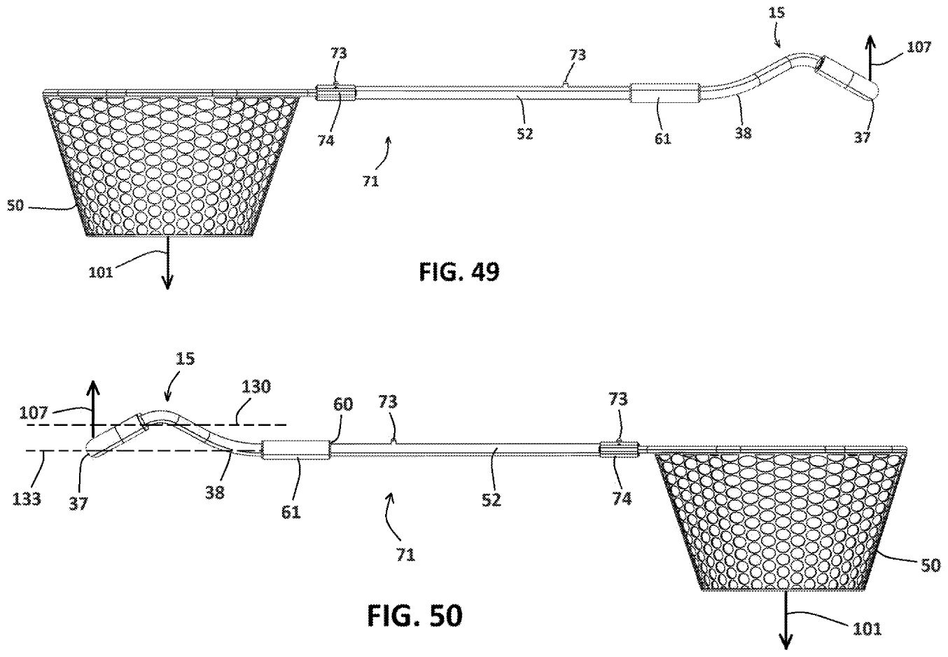

Referring now to the drawings with more specificity, the presently disclosed subject matter is firstly directed to a first grabber tool 10′. A second grabber tool as at 10′ is also disclosed and described after first describing the first grabber tool 10. The grabber tool 10 according to the presently disclosed subject matter essentially enable a user to grab objects with an extended reach. To achieve this primary objective, the grabber tool 10 according to the presently disclosed subject matter comprise a centrally located handle mechanism 12, a distally extending elongate arm portion 13, a distally located pincher mechanism 14, and a proximally located arm support portion 15. The grabber tools 10/10′ and elements thereof are supported by FIG. 1-40. Other secondary embodiments, including exemplary fishing tools are supported by FIG. 41-50.

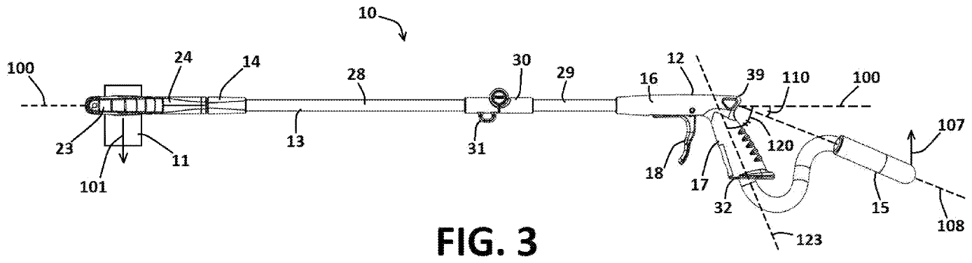

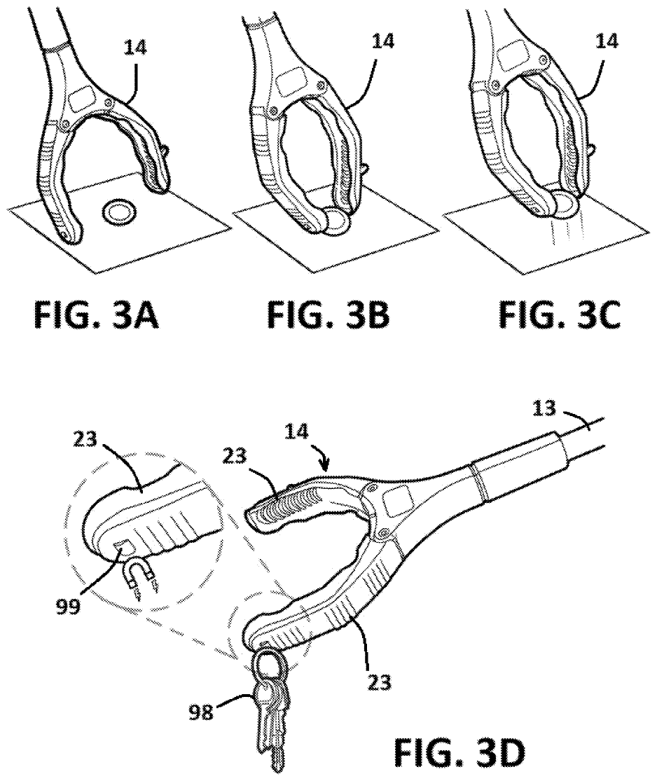

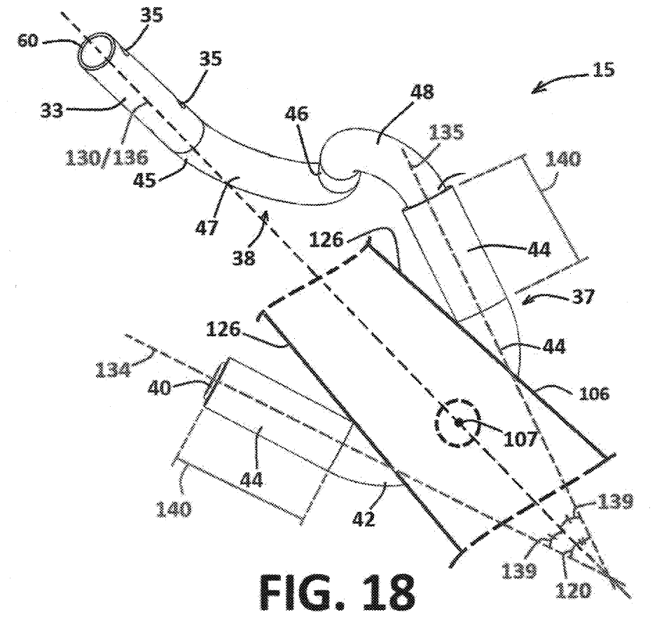

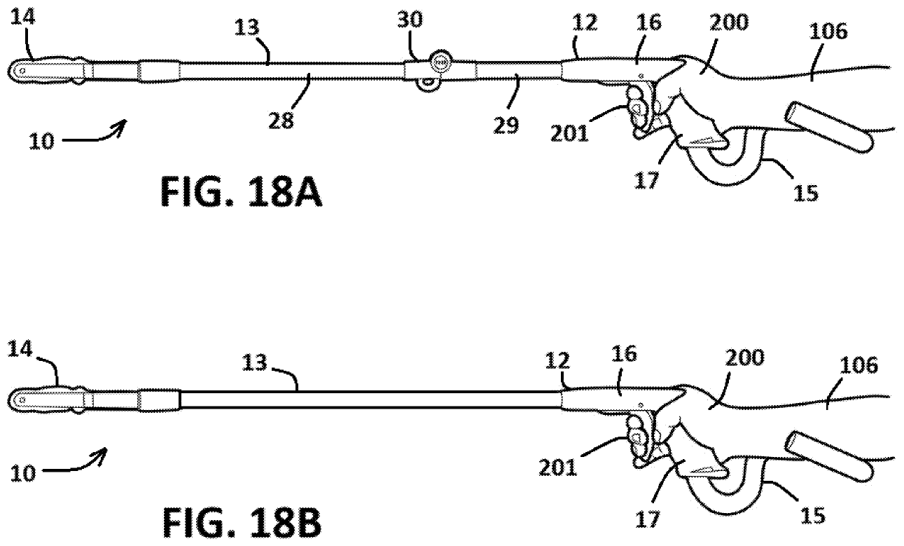

Firstly referring to the grabber tool 10, the handle mechanism 12 is configured to be ergonomically received in a user's hand and in some embodiments is generally shaped in much the same manner as a pistol as generally depicted in FIGS. 18A and 18B. More particularly, the handle mechanism 12 comprises an upper handle or barrel portion as at 16 and a lower handle portion or grip portion 17. The lower handle portion 17 extends along a grip axis 123 and is angled relative to the upper handle portion 16 at a handle angle 120 as referenced in FIG. 3. The handle mechanism 12 further comprises a trigger mechanism as at 18. The trigger mechanism 18 generally extends intermediate the upper handle portion 16 and the lower handle portion 17 and is configured to enable the user's hand 200 or fingers 201 to selectively direct a trigger portion 19 of the trigger mechanism 18 toward the lower handle portion 17.

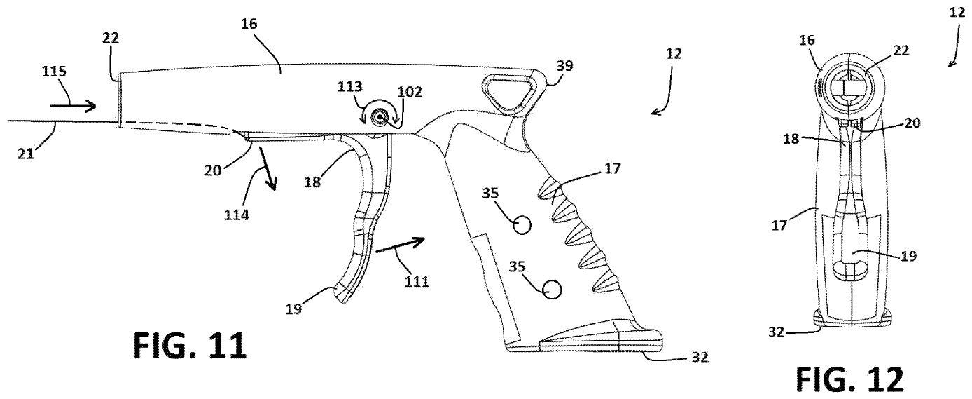

In some embodiments, the trigger mechanism 18 is pivotally connected to the upper handle portion 16 and pivots as at 113 about a trigger axis of rotation 102 when the trigger portion 19 is directed as at vector 111 toward the lower handle portion 17 as referenced in FIG. 11. A distal trigger portion 20 of the trigger mechanism 18 is directed as at vector 114 when the trigger portion 19 is directed as at vector 111. The distal trigger portion 20 is connected to a cable 21, which cable 21 extends through the distal arm end 22 of the upper handle portion 16 and through the distally extending elongate arm portion 13 to the distally located pincher mechanism 14. The elongate arm portion 13 extends distally along an arm axis 100 of the elongate arm portion 13 from the distal arm end 22 of the upper handle portion 16 and comprises a proximal handle end 26 and a distal pincher end 27. The handle angle 120 extends intermediate the arm axis 100 and the grip axis 123.

In some embodiments, the distally extending elongate arm portion 13 may comprise a distal arm portion 28 comprising a substantially rigid material (e.g., a tubular metallic material construction) and a proximal arm portion 29 comprising a substantially rigid material (e.g., a tubular metallic material construction) interconnected by an optional pivot mechanism 30. In some embodiments, the distal arm portion 28 comprises a pivot connector arm end 54 and the proximal arm portion 29 comprises a pivot connector arm end 55. In some embodiments, the pivot connector arm ends 54 and 55 mate with (female) opposed end-receiving portions 56 of the pivot mechanism 30, further optionally outfitted with push button release mechanism 57. The push button release mechanism 57 is operable to selectively lock the elongate arm portion 13 in an extended configuration and unlock the pivot mechanism 30 so as to be able to pivot the distal arm portion 28 relative to the proximal arm portion 29 to a collapsed, stowage configuration.

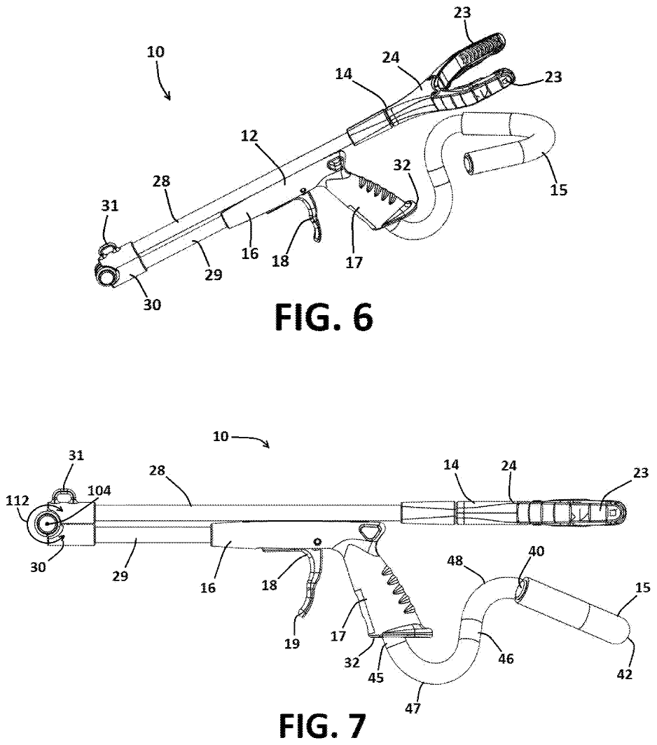

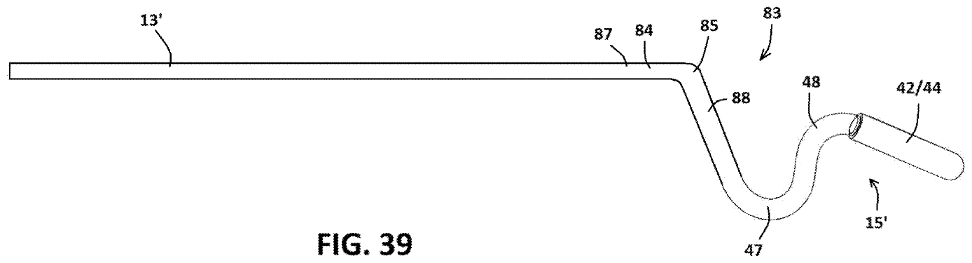

The extended configuration of the grabber tool 10 with pivotal elongate arm 13 is generally depicted in FIG. 1-5 and 18A, and the collapsed, stowage configuration of the grabber tool 10 with pivotal elongate arm 13 is generally depicted in FIG. 6-9. The optional pivot mechanism 30 enables the user to rotate as at 112 the distal arm portion 28 and pincher end 27 about an arm axis of rotation 104 relative to the proximal arm portion 29 and handle end 26 thereby collapsing the grabber tool 10 into a relative more compact or shorter stowage configuration as generally depicted. In some embodiments, the pivot mechanism 30 may further comprise a loop member 31 that extends outwardly therefrom for enabling a user to support or hang the grabber tool 10 upon a hook member or similar other structure for storage. In some embodiments, the grabber tool 10 may eliminate the pivot mechanism 30 and a singular, non-pivotal elongate arm portion 13 may be provided as for example, in the case of the elongate arm portion 13 of the grabber tool 10 as referenced in FIG. 18B or in the case of the elongate arm portion 13′ of the grabber tool 10′ as referenced in FIG. 39.

In some embodiments, the distally located pincher mechanism 14 comprises laterally opposed grabber elements or arms as at 23. The laterally opposed grabber elements 23 are pivotally attached to a main body 24 of the pincher mechanism 14 and are pivotal as at arrow 116 about grabber arm axes of rotation as at 103. When the force-transferring cable 21 is directed as at vector 115 proximally toward the lower handle portion 17 by way of the trigger mechanism 18, the force-transferring cable 21 transfers the user-imparted trigger force 111 into the grabber elements 23 which then rotate as at arrows 117 about the grabber arm axes of rotation as at 103 to pinch or grab the object 11 as at vectors 118.

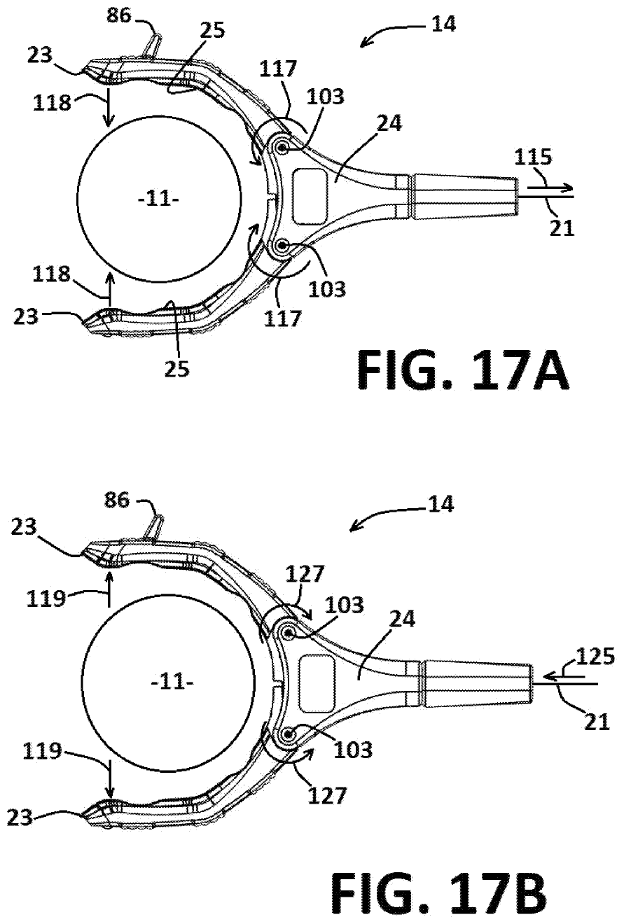

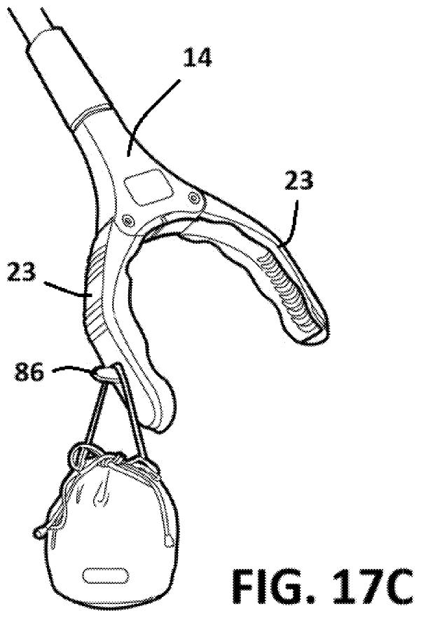

In some embodiments, the grabber elements 23 may be inwardly outfitted with pliable, high friction materials and configurations as at 25 to better grip objects as it is grabbed or pinched by the pincher mechanism 14 as generally depicted in FIG. 3A-3C in connection with a relatively small object. In some embodiments, the grabber elements 23 may be outwardly outfitted with a magnet 99 for magnetically attracting ferromagnetic objects as for example, a set of keys 98 as generally depicted in FIG. 3D. In some embodiments, one or more grabber elements 23 may comprise an outwardly extending object-hooking extension member 86 as referenced at 86 in FIG. 17A-17C. A simplistic view of the object-hooking extension member 86 hooking a looped object is generally shown in FIG. 17C.

In some embodiments, the pincher mechanism 14 may comprise at least one internal spring mechanism (not specifically illustrated) within the main body 24 for returning the grabber elements 23, which then rotate as at arrows 127 about the grabber arm axes of rotation as at 103 to the open position 105 and directing 125 the cable 21 toward the pincher mechanism 14 as generally depicted and referenced in FIG. 17B when the trigger force 111 is removed from the trigger mechanism 18. It will thus be understood the pincher mechanism 14 operably extends from the pincher end 27 and is operatively coupled or connected to the trigger mechanism 18 by way of the force-transferring cable 21. The trigger mechanism 18 essentially functions to selectively close the pincher mechanism 14 for grabbing or pinching an object 11, and when the user releases the trigger portion 19, the grabber elements 23 return to the open position 105 for releasing the object 11 as at arrows 119.

The foregoing descriptions in support of the handle mechanism 12, the elongate arm portion 13, and the pincher mechanism 14 of the grabber tool 10 are fairly typical of state-of-the-art grabber tools. Central to the practice of the presently disclosed subject matter, and distinct from the state-of-the-art, is the arm support portion 15 or feature attached proximally relative to the handle mechanism 12, the elongate arm portion 13, and the pincher mechanism 14 of the grabber tool 10. The proximally located arm support portion 15 extends from a support end 32 of the lower handle portion 17 opposite the distally extending elongate arm portion 13 for essentially providing a fulcrum point at the handle mechanism 12.

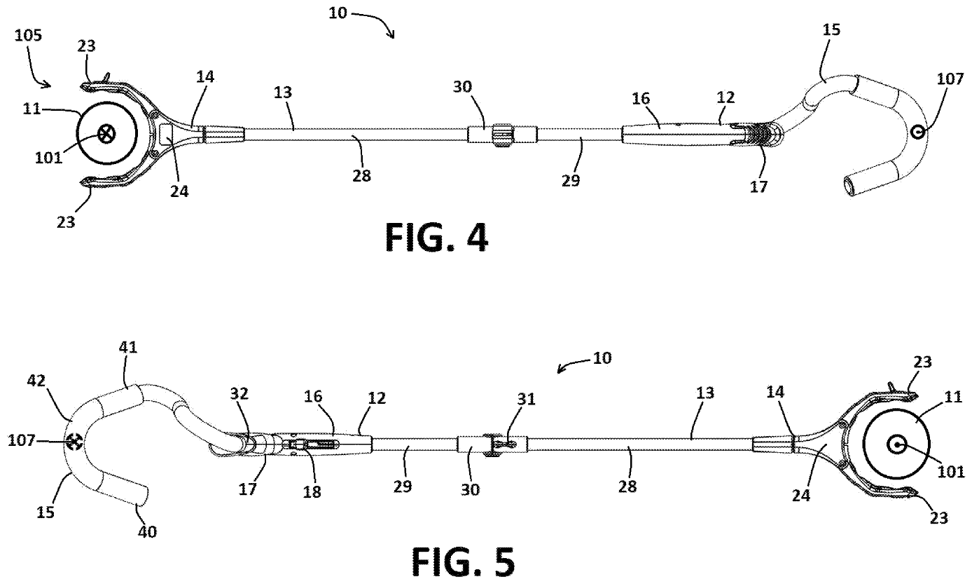

In this regard, the proximally located arm support portion 15 is configured to engage lower (or medial) portions of a user's forearm as at 106 for countering or balancing an object load or weight 101 at the pincher mechanism 14 when a user grabs an object. A generic object is referenced at 11, for example, in FIGS. 4, 17A and 17B. The arm support portion 15 provides a structural basis for enabling static equilibrium by way of a directed balancing force 107 equal and opposite to the load or weight 101 into the user's forearm 106 in proximally spaced relation to the handle mechanism 12 for relieving anatomical strain at or about the user's hand and radiocarpal joint.

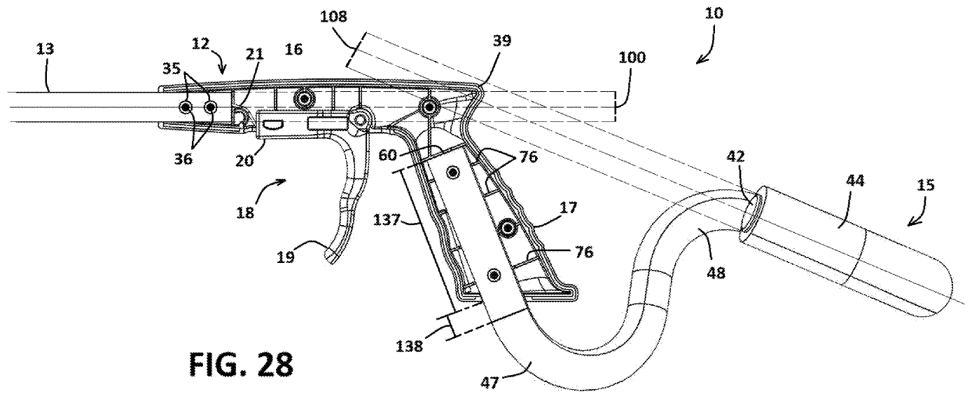

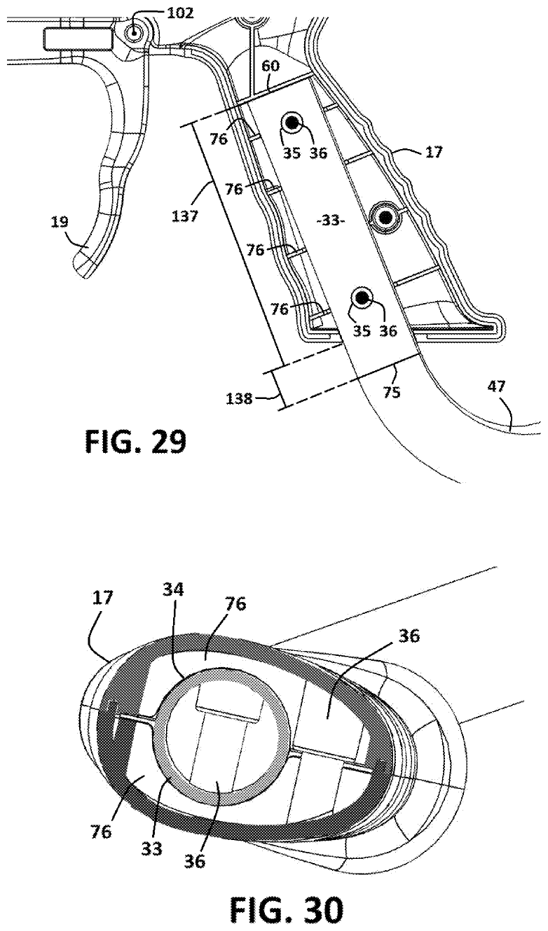

In some embodiments, the proximally located arm support portion 15 may further comprise a male handle mating portion 33 and the handle mechanism 12 may comprise a female support mating portion 34 as incorporated into grabber tool 10. The male handle and female support mating portions 33 and 34 are matable for attaching the arm support portion 15 to the handle mechanism 12 in some embodiments. In some embodiments, the male handle mating portion 33 extends from the tool-engaging end 60 toward a lower mating portion end 75 such that, when mated with a female support mating portion 34 of the handle mechanism 12, an internal mating length 137 of the male handle mating portion 33 is greater than an external length 138 of the male handle mating portion 33 at the lower mating portion end 75 as generally depicted and referenced in FIGS. 28 and 29.

In some embodiments, the lower handle portion 17 may comprise an internal array of rib elements 76 spaced relative to one another along the internal mating length 137 together configured to define the female support mating portion 34. In other words, the internal array of rib elements 76 is configured to maintain axial alignment of the male handle mating portion 33 relative to the female support mating portion 34 when mated. In some embodiments, the male handle mating portion 33 and the female support mating portion 34 each comprise corresponding fastener-receiving apertures 35 formed in spaced relation to one another along the internal mating length 137 for receiving fasteners 36 configured to fasten the male handle mating portion 33 to the female support mating portion 34. This provides relatively robust securement of the arm support portion 15 to the handle mechanism 12 of the grabber tool 10. The grabber tool 10', by comparison, comprises a singular tubular member 83 that extends through the handle mechanism 14′ so that a separate mating attachment of the arm support portion 15′ is eliminated.

In some embodiments, the proximally located arm support portions 15/15′ are generally and tortuously and generally S-shaped in three dimensions and comprise a proximal arm-engaging angled portion 37 and a distal support-to-fulcrum angled portion 38. The proximal arm-engaging angled portion 37 extends in a radiused arm portion plane or first radiused portion plane 108 and the distal support-to-fulcrum portion 38 extends in a third radiused portion plane 109. The first and third radiused portion planes 108 and 109 of the proximal arm-engaging angled portion 37 and the distal support-to-fulcrum portion 38 are angled relative to one another so as to position the proximal arm-engaging angled portion 37 and first radiused portion plane 108 to extend obliquely at an angle of 20 to 25 degrees as at angle 110 relative to the arm axis 100 or a forearm axis 130 of a user's forearm 106. In some embodiments, the first radiused portion plane 108 of the proximal arm-engaging angled portion 37 extends through a grip end 39 of the upper handle portion 16 at a junction thereof with the lower handle portion 17 such that the first radiused portion plane 108 is obliquely angled between the arm axis 100 and the grip axis 123 as at angle 110 as comparatively referenced in FIGS. 3 and 28.

In some embodiments, the proximal arm-engaging angled portion 37 comprises a linear first support segment 40, a linear second support segment 41 and an arm-engaging radiused portion 42 extending intermediate the linear first and second support segments 40 and 41. The arm-engaging radiused portion 42 is configured for engaging a medial portion of the user's forearm 106 intermediate the proximal and distal portions thereof and directing balancing force 107 thereinto generally within a vertical plane extending through arm axis 100. In some embodiments, the linear first and second support segments 40 and 41 flank outer (anterior and posterior) portions 126 of the user's forearm 106 for further engaging the user's forearm 106 and increasing the support function of the arm-engaging angled portion 37.

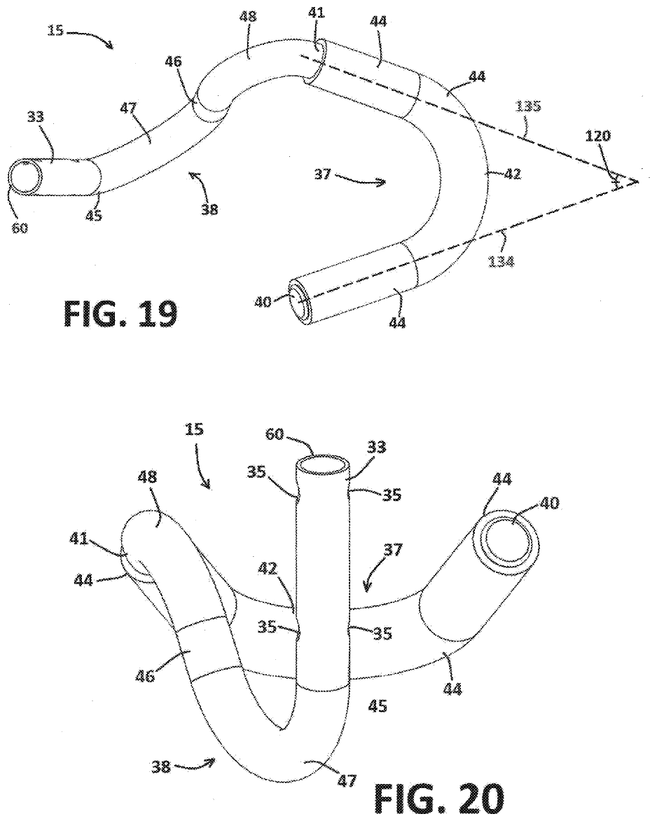

In some embodiments, the linear first and second support segments 40 and 41 are angled within a range of 30 to 50 degrees, and in some more particular embodiments 40 degrees with respect to one another as at angle 120 as generally depicted in FIG. 19. These angular relationships are exemplary and not meant to be limiting. In some embodiments, the first support segment 40 extends along a first segment axis 134 and the second support segment 41 of equal length 140 to the first support segment 40 extends along a second segment axis 135. The axes 134 and 135 are obliquely angled relative to one another as at angle 120. The first and second support segments 40 and 41 are equally angled as at angles 139 relative to a median support plane 136 extending through the handle mating portion 33.

In some embodiments, at least a portion of the arm-engaging angled portion 37 comprises a padded exterior surface 44 for providing a padded interface intermediate the user's forearm 106 and the arm-engaging angled portion 37 for enhancing comfort and reducing spacing between opposed surfaces at the user's forearm 106 when the balancing force 107 is directed thereinto during use of the grabber tools 10/10′. The padded exterior surface(s) 44 not only help to disperse the balancing force 107 over a larger surface area, but also help stabilize the arm-engaging angled portion 37 at the user' forearm 106.

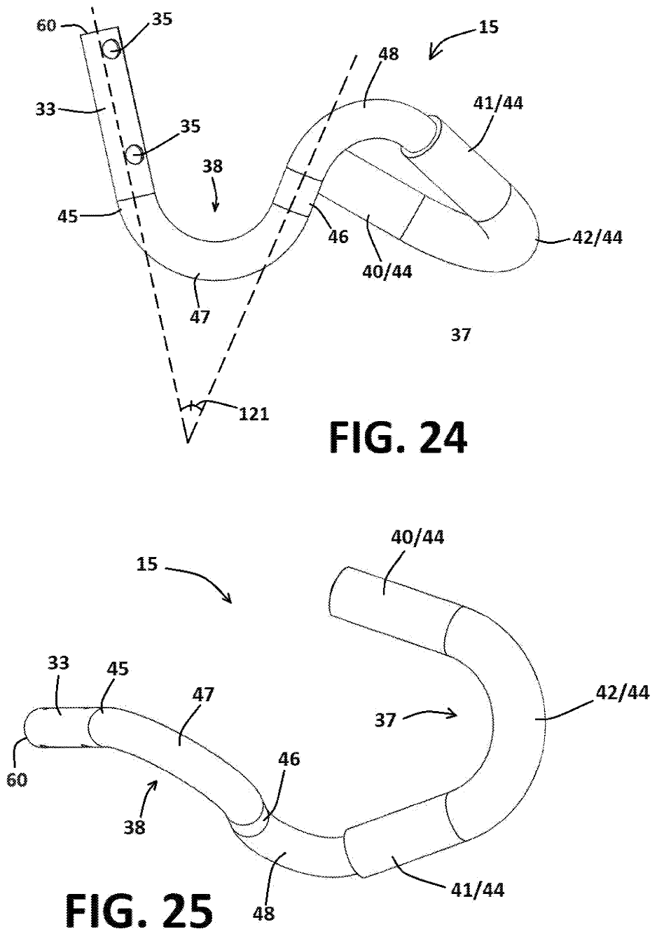

In some embodiments, the distal support-to-fulcrum angled portion 38 comprises a first angle segment 45 coextensive with the handle mating portion 33, a second angle segment 46, and a handle-engaging radiused portion 47 extending intermediate the first and second angle segments 45 and 46. In some embodiments, the first and second angle segments 45 and 46 are within a range of 25 to 45 degrees, and in some embodiments 35 degrees with respect to one another as at angle 121 in FIG. 24. In some embodiments, the distal support-to-fulcrum angled portion 38 is connected to the proximal arm support angled portion 37 by way of a central radiused portion 48 extending intermediate the second angle segment 46 of the distal support-to-fulcrum angled portion 38 and the second support segment 41 of the proximal arm support angled portion 37 thereby providing the three-dimensional tortuous and generally S-shaped arm support portions 15/15′.

In some embodiments, the central radiused portion 48 extends in a second radiused portion plane as at 122 in FIG. 36. The first, second and third radius portion planes 108, 122 and 109 differ from one another and respectively extend in planes peripheral to the handle mechanisms 14/14′. In other words, the arm-engaging radiused portion 42, the central radiused portion 48, and the handle-engaging radiused portion 47 each extend in a respective and differing radiused portion planes wherein the central radiused portion 48 support interconnection of the arm-engaging radiused portion 42 and the handle-engaging radiused portion 47.

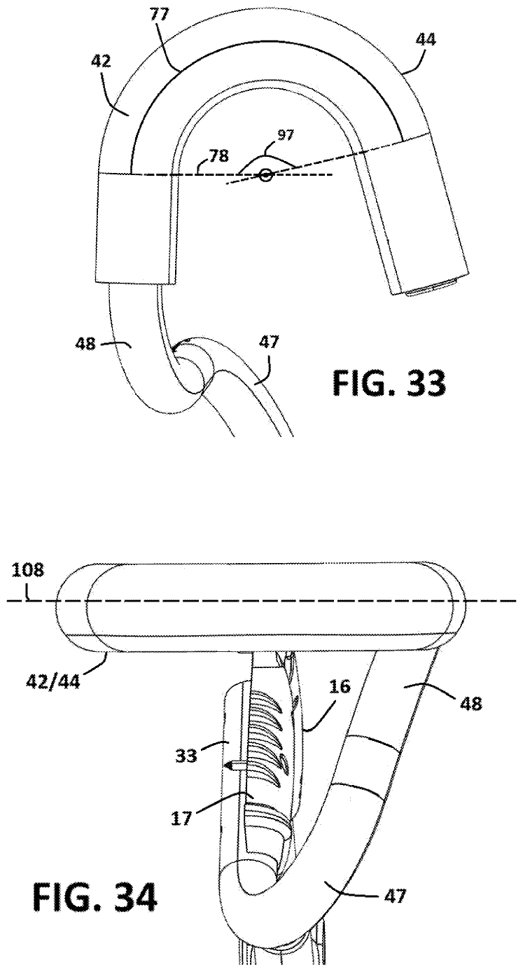

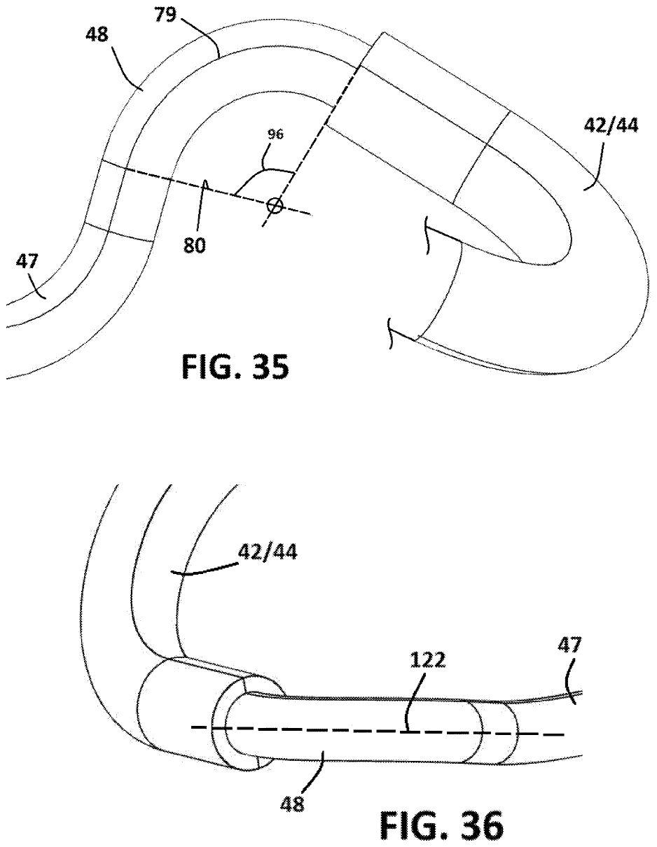

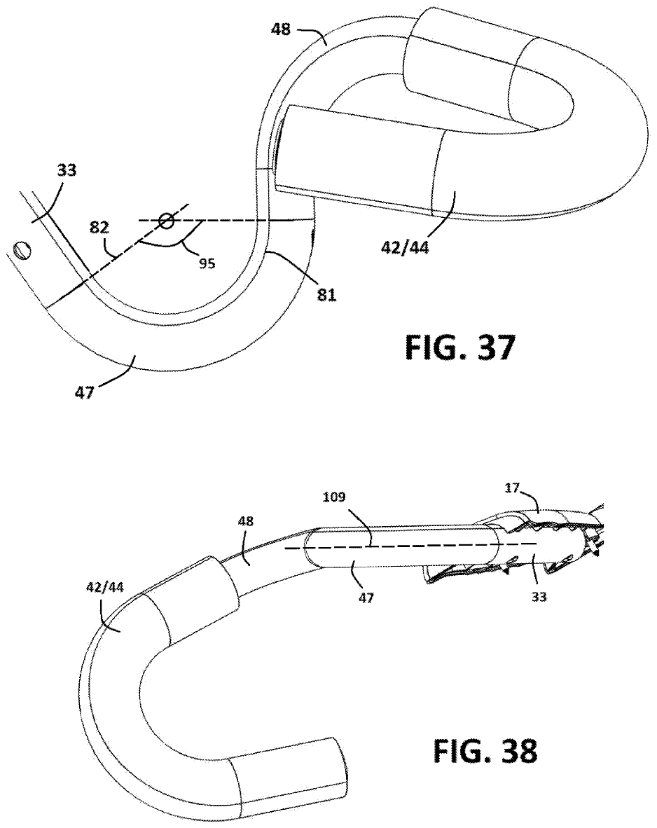

The arm-engaging radiused portion 42, the central radiused portion 48, and the handle-engaging radiused portion 47 each further extend through a respective and differing arc length so as to properly position and orient the arm-engaging radiused portion 42 for engaging the user's forearm 106. The arm-engaging radiused portion 42 extends through a first arc length as at 77 determined by the central angle 97 and the radius 78 as depicted and referenced in FIG. 33. The central radiused portion 48 extends through a second arc length as at 79 determined by the central angle 96 and the radius 80 as depicted and referenced in FIG. 35. The handle-engaging radiused portion 47 extends through a third arc length 81 determined by the central angle 95 and the radius 82 as depicted and referenced in FIG. 37.

An arc length may be defined as the distance between two points along a section of a curve or the circumference of a circle. It represents a portion of the total circumference of a circle, determined by the central angle. When the central angle is in radians, the arc length formula is simply: arc length(s)=radius (r)×central angle (θ). In some embodiments, the first arc length 79 of the arm-engaging radiused portion 42 is greater than both the second arc length 79 of the central radiused portion 48 and the third arc length 81 handle-engaging radiused portion 47. In some embodiments, the third arc length 81 of the handle-engaging radiused portion 47 is greater than the second arc length 79 of the central radiused portion 48.

Accordingly, in some embodiments, it will thus be understood the first arc length 77 of the arm-engaging radiused portion 42 is greatest in magnitude relative to the second arc length 79 and the third arc length 81, and extends in the first radiused portion plane 108 as comparatively depicted in FIGS. 33 and 34. Further, in some embodiments, it will be understood the second arc length 79 of the central radiused portion 48 is of least magnitude relative to the first arc length 77 and the third arc length 81 and extends in the second radiused portion plane 122 as comparatively depicted in FIGS. 35 and 36. Lastly, the third arc length 79 of the central radiused portion 48 is of intermediate magnitude relative to the first arc length 77 and the second arc length 81 and extends in the third radiused portion plane 109 as comparatively depicted in FIGS. 37 and 38. The central angle 97 is greater than the central angle 95 and the central angle 95 is greater than the central angle 96 in some embodiments.

The arm support portions 15/15′ are configured to orient the forearm axis 130 of a user's forearm 106 toward the handle mechanisms 12/12′ in parallel relation to the upper handle portions 16/16′ and the elongate arm portions 13/13′. At least the elongate arm portions 13/13′ and the pincher mechanism 14 together have a combined weight directed downwardly such that the arm-engaging radiused portion 42 is directed upwardly toward the user's forearm 106 about a fulcrum point at the handle mechanism 12. The arm support portions 15/15′ thereby counterbalance a load associated with the pincher mechanisms 14/14′.

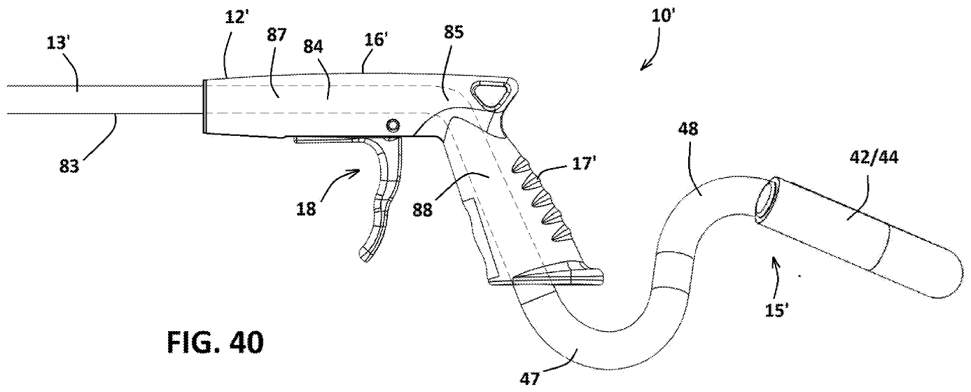

To avoid having differing connection points between the elongate arm portion 13 and the arm support portion 15 to the handle mechanism 14, the presently disclosed subject matter contemplates grabber tool 10′ comprising a singular tubular member 83 as generally depicted and referenced in FIGS. 39 and 40. The tubular member 83 comprises an elongate arm portion 13′, a through-handle portion 84 and an arm support portion 15′. The through-handle portion 84 comprises a radiused handle portion 85, an upper tube portion 87 and a lower tube portion 88. The arm support portion 15′ has an array of radiused portions substantially as described hereinabove, including an arm-engaging radiused portion 42, a central radiused portion 48, and a handle-engaging radiused portion 47.

The through-handle portion 84 extends through the handle mechanism 12′ such that the radiused handle portion 85 extends through the upper handle portion 16′ and the lower handle portion 17′ such than the upper tube portion 87 is angled relative to the lower tube portion 88 at the radiused handle portion 85. The arm-engaging radiused portion 42, the central radiused portion 48, and the handle-engaging radiused portion 47 each extend in a respective and differing radiused portion planes 108, 122 and 109 such that the central radiused portion 48 interconnects the arm-engaging radiused portion 42 and the handle-engaging radiused portion 47. The arm support portion 15′ is thereby configured to orient a forearm axis 130 of a user's forearm 106 toward the handle mechanism 12′ in parallel relation to the upper handle portion 16′. The grabber tool 10′ thereby provides a relatively more robust integrated grabber tool whereby the fulcrum point at the handle mechanism 12′ further relieves stress not only at the user's hand 200 and peripheral wrist region, but also at the handle mechanism 12′.

The presently disclosed subject matter further contemplates usage of the arm support portions 15/15′ in combination with any number of load-bearing tools, the distal ends of which bear a load or weight 101 as might be the case with the weight of a fish 53 on the end of a fishing rod 49 as generally depicted in FIG. 41 or a load 101 from a fishing net 50 or similar other net apparatus as generally depicted in FIG. 42. In this regard, it is contemplated the arm support portions 15/15′ according to the presently disclosed subject matter may similarly transfer the balancing load 107 to a user's forearm 106 for reducing strain at the hand or radiocarpal joint in such applications. A modified handle mechanism 51 may be attached to the arm support portions 15/15′ in much the same manner as handle mechanisms 12/12′ to provide a fulcrum point for the load balance function opposite an elongate arm portion 52 of such load-bearing tools. The handle mechanism 51, in certain embodiments, may, for example eliminate the trigger mechanism 18 otherwise associated with handle mechanisms 12/12′ as generally and comparatively depicted in FIGS. 41 and 42.

Accordingly, in some embodiments, the arm support portions 15′15′ are usable in combination with a grabber tool 10 or grabber tool 10′, for example, and in some embodiments, the arm support portions 15/15′ are usable in combination with a fishing tool, for example. The exemplary fishing tool may be characterized by a fishing rod as at 49 or a fishnet as at 50 as generally and respectively depicted in FIGS. 41 and 42. The arm support portions 15/15′ according to the presently disclosed subject matter may be said to be usable in combination with a select load-bearing tool, which select load-bearing tool may be selected from the group consisting of grabber tools 10/10′ and a fishing tool as exemplified by a fishing rod or fishnet 50.

In some embodiments, the arm support portions 15/15′ according to the presently disclosed subject matter may be said to comprise a tubular body (of tubular metallic material construction) having at least three bends or radiused portions each defining a distinct structural plane and terminating in a tool-engaging end 60. Stated another way, the arm support portions 15/15′ according to the presently disclosed subject matter may be said to comprise a tubular body having an S-shape in three dimensions comprising an upward slanting arm-engaging angled portion as at 37 and a support-to-fulcrum angled portion as at 38. A first of the radiused portion planes comprises the upward slanting arm-engaging angled portion 37 opposite the tool-engaging end 60. The arm-engaging angled portion 37 comprises one of the bends disposed between a pair of support segments. First and second support segments of the arm-engaging angled portion 37 are respectively referenced at 40 and 41. Intermediate the first and second support segments 40 and 41 is a bend or arm-engaging radiused portion as at 42.

The bends or radiused support segments of the arm support portion 15 cooperate to orient a forearm axis 130 of a user's forearm 106 toward the tool-engaging end 60. The tool-engaging end 60 is coextensive with or otherwise attachable to or in line with a load-bearing tool as exemplified by a grabber tool 10, fishing net 49 or fishnet 50 inherently having a tool weight as at 131. In some applications, the load-bearing tool may hold a generic object as depicted and referenced at 11, which object 11 has a weight or load as generally referenced at vector 101. The arm support portion 15 is coextensive with or attachable to or in line with a load-bearing tool at least a weight 131 of which is directed downwardly as at vector 132 such that the arm-engaging angled portion 37 is directed upwardly toward the user's forearm 106 about a fulcrum point intermediate the tool-engaging end 60 and the arm-engaging angled portion 37 thereby counterbalancing a load associated with the load-bearing tool as exemplified by loads 101 and/or 131. In some embodiments, a handle portion or handle mechanism is provided at the fulcrum point such at which point a user's hand grips the ensemble.

In some embodiments, the arm-engaging angled portion 37 extends in a first radiused portion plane as at 108 and the support-to-fulcrum angled portion 38 extends in a third radiused portion plane 109, which first and third radiused portion planes 108 and 109 are obliquely angled relative to one another. In some embodiments, the first radiused portion plane 108 extends obliquely relative to the forearm axis 130 of the user's forearm 106 such that the first radiused portion plane 108 extends through a proximal end or grip end 39 of the upper handle portion 16. In some embodiments, the arm-engaging angled portion 37 of the arm support portion 15 comprises a first support segment 40, a second support segment 41 and an arm-engaging radiused portion 42 extending intermediate the first and second support segments 40 and 41 such that the arm-engaging radiused portion 42 is configured for engaging a first portion of the user's forearm 106.

In some embodiments, the first and second support segments 40 and 41 flank outer portions of the user's forearm 106 for further engaging outer portions of the user's forearm 106 and increasing the support function of the arm-engaging angled portion 37. The support-to-fulcrum angled portion 38 comprises a first angle segment as at 45, a second angle segment as at 46 and a handle-engaging radiused portion 47 extending intermediate the first and second angle segments 45 and 46. The support-to-fulcrum angled portion 38 of the arm support portion 15 is connected to the arm-engaging angled portion 37 by way of a central radiused portion 48. In some embodiments, the first angle segment 45 is coextensive with a handle mating portion 33 the end of which provides a tool-engaging end 60. In some embodiments, the first angle segment 45 is coextensive with a handle grip portion 61 the end of which provides a tool-engaging end 60. The tool-engaging end 60 is coextensive with or otherwise connectable to a select load-bearing tool as alluded to above.

In a first exemplary application, the arm support portion 15 according to the presently disclosed subject matter is usable in combination with a grabber tool 10 for generally enabling a user to grab objects from a distance greater than a user's natural arm length. A generic target object is depicted and referenced at 11, which generic target object 11 has a weight or load as generally referenced at vector 101. As prefaced above, similar tools are known in the art, and are commonly referred to as grabber tools, reacher tools, grabber reacher aids, trash grabbers, trash picker tools, plier tools, and the like. The distal ends of these types of grabber tools are generally outfitted with some type of pincher mechanism that is operable to pinch or grab an object so that the user may then reorient the tool and bring the grabbed object closer to the user's person without the need to bend, stand, reach, or climb upon secondary support structures to reach the targeted object.

As further introduced above, state-of-the-art tools of this type are typically configured such that the weight 101 of the object(s) so grabbed are directed into the user's hand and radiocarpal joint by way of the elongated arm portion of the tools, thereby placing stress or strain upon the hand and/or radiocarpal joint causing discomfort or possible injury to the user in many instances. The grabber tool 10 according to the presently disclosed subject matter helps shift moment away from the user's hand, the radiocarpal joint and peripheral anatomy toward the user's arm, which anatomy is better suited to provide static equilibrium with less strain at the user's hand and radiocarpal joint. The shift of the balancing force 107 thereby decreases discomfort at the hand/joint during usage and improving overall stability and usage of the grabber tool 10, particularly for user's who have experienced previous injury to the anatomical areas or users who have experienced a decline in structural strength in these anatomical areas, for example, the elderly.

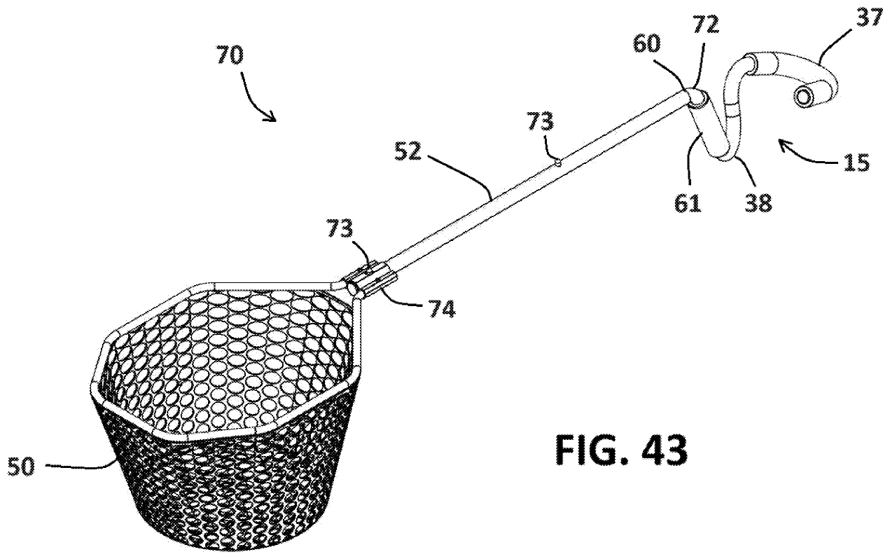

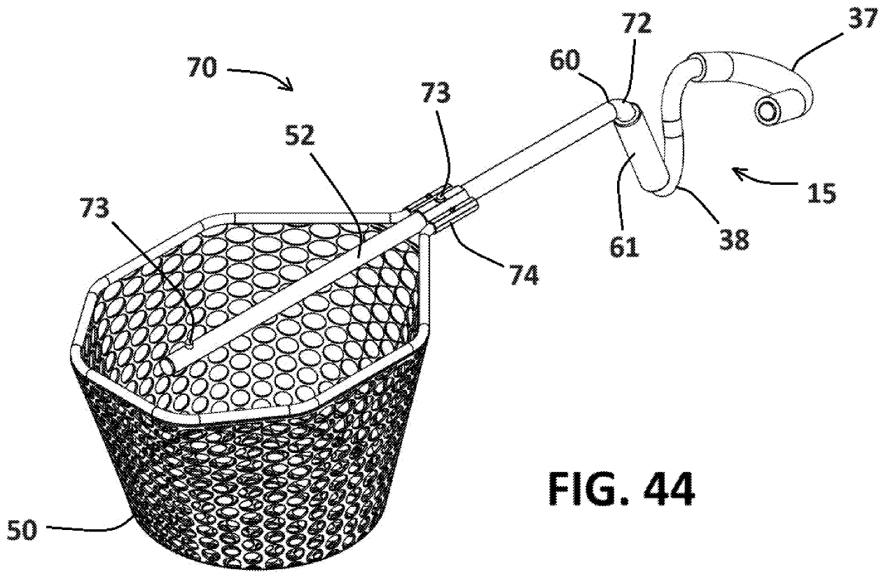

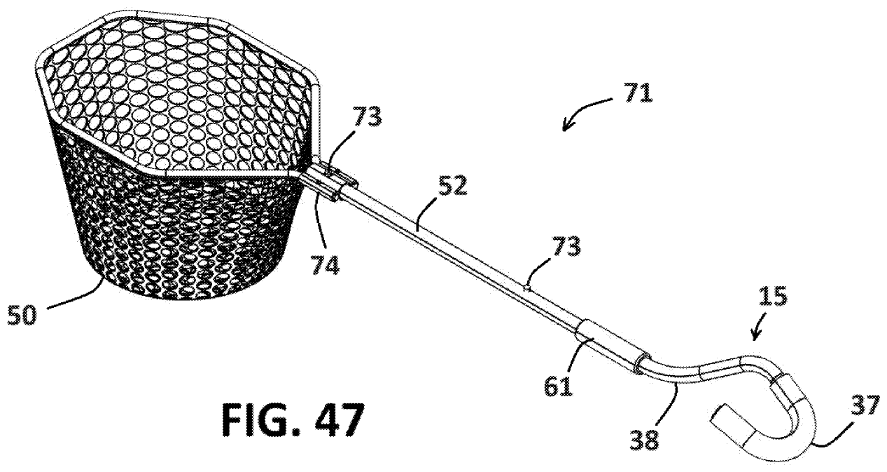

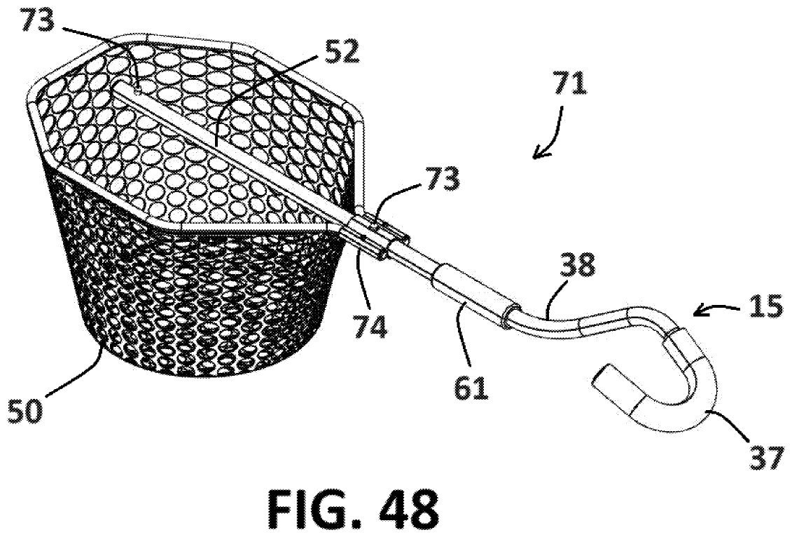

To help further illustrate a further exemplary application according to the presently disclosed subject matter, certain fishing tools are generally depicted and referenced in FIGS. 43-50 . The fishing tools accordingly to the presently disclosed subject matter do not require a pincher mechanism and do not require a trigger mechanism. Accordingly, the fishing tools according to the presently disclosed subject matter eliminate the handle mechanisms 12/12′ and the pincher mechanism 14 but may include a fishnet 50 opposite the arm support portions 15/15′. Two variations of fishing or fishnet tools are generally depicted and referenced at 70 and 71. The fishnet tool 70 comprises a handle grip portion 61 obliquely angled relative to the elongate arm portion 52 and the fishnet tool 71 comprises a handle grip portion 61 axially aligned with the elongate arm portion 52 as generally and comparatively depicted in FIGS. 43 and 44 versus FIGS. 47 and 48. In some embodiments, the arm support portion 15 comprises a fourth bend or radiused segment 72 intermediate the fulcrum point at the handle grip portion 61 and the tool-engaging end 60 for orienting an axis 133 of the tool-engaging end 60 in parallel or coaxial relation relative to the forearm axis 130 of the user's forearm 106.

The fishnet tools 70 and 71 according to the presently disclosed subject matter may be configured to provide an extended configuration as generally and comparatively depicted in FIGS. 43 and 45-47 versus a collapsed, stowage configuration as generally and comparatively depicted in FIGS. 44 and 48. In some embodiments, the fishnet tools 70 and 71 comprise elongate arm portions 52 outfitted with proximally and distally located spring-biased buttons 73 matable with a button-receiving aperture formed in a neck portion 74 that slidably moves along the elongate arm portion 52 intermediate the extended configuration and the collapsed, stowage configuration. The buttons 73 may be selectively depressed to unlock the neck portion 74 from either the extended configuration or the collapsed, stowage configuration to allow the user to move the fishnet 50 intermediate the two configurations.

While the above descriptions contain much specificity, this specificity should not be construed as limitations on the scope of the presently disclosed subject matter, but rather as an exemplification thereof. There is firstly provided in accordance with an embodiment according to the presently disclosed subject matter a grabber tool for enabling a user to grab objects. In some embodiments, the grabber tool according to the presently disclosed subject matter comprises a handle mechanism, an elongate arm portion, a pincher mechanism, and an arm support portion. The handle mechanism is configured to be ergonomically received in a user's hand, and comprises an upper handle portion, a lower handle portion angled relative to the upper handle portion along a grip axis, and a trigger mechanism extending intermediate the upper handle portion and the lower handle portion configured to enable at least a portion of the user's hand to selectively direct a trigger portion thereof toward the lower handle portion.

The elongate arm portion extends distally from a first handle end of the upper handle portion along an arm axis. The upper handle portion extends along the arm axis, and the lower handle portion extends along a grip axis obliquely angled relative to the arm axis at a handle angle. The pincher mechanism operably extends distally from the elongate arm portion and is operatively coupled to the trigger mechanism. The trigger mechanism is operable to selectively close the pincher mechanism via the elongate arm portion.

The arm support portion has an array of radiused portions, including an arm-engaging radiused portion, a central radiused portion, and a handle-engaging radiused portion. The arm-engaging radiused portion, the central radiused portion, and the handle-engaging radiused portion each extend in a respective and differing radiused portion plane. The central radiused portion supportively interconnects the arm-engaging radiused portion and the handle-engaging radiused portion. The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism, the arm support portion thereby counterbalancing a load associated with the pincher mechanism.

In some embodiments, the lower handle portion comprises a female support mating portion therewithin, and the handle-engaging radiused portion terminates in a tool-engaging end with a male handle mating portion extending therefrom. The male handle mating portion is matable with the female support mating portion. In some embodiments, the female support mating portion is mated with the male handle mating portion such that an internal mating length of the male handle mating portion is greater than an external length of the male handle mating portion. In some embodiments, the lower handle portion comprises an internal array of rib elements spaced relative to one another along the internal mating length together configured to define the female support mating portion. The internal array of rib elements is configured to maintain axial alignment of the male handle mating portion relative to the female support mating portion.

In some embodiments, the male handle mating portion and the female support mating portion each comprise corresponding fastener-receiving apertures in spaced relation to one another along the internal mating length for receiving fasteners configured to fasten the male handle mating portion to the female support mating portion. In some embodiments, the arm-engaging radiused portion extends within a radiused arm portion plane or a first radiused portion plane obliquely angled relative to the arm axis such that the first radiused portion plane extends through a grip end of the upper handle portion at a junction thereof with the lower handle portion. In some embodiments, the radiused arm portion plane is obliquely angled between the arm axis and the grip axis.

In some embodiments, the arm-engaging radiused portion comprises opposed linear first and second support segments extending from terminal ends of an arc length thereof configured to flank outer portions of the user's forearm equidistantly from the forearm axis. In some embodiments, the arm-engaging radiused portion comprising a first support segment extending along a first segment axis, a second support segment of equal length to the first support segment extending along a second segment axis obliquely angled relative to the first support segment, and a radiused support segment extending intermediate the first and second support segments.

In some embodiments, the first and second support segments are equally angled relative to a median support plane extending through the male handle mating portion. The radiused support segment is configured for engaging the user's forearm. In some embodiments, at least a portion of the arm-engaging radiused portion comprises a padded exterior surface for providing a padded interface intermediate the user's forearm and the arm-engaging radiused portion.

There is provided in accordance with an embodiment according to the presently disclosed subject matter a grabber tool for enabling a user to grab objects. The grabber tool comprises a handle mechanism, an elongate arm portion, a pincher mechanism, and an arm support portion. The handle mechanism comprises an upper handle portion, a lower handle portion, and a trigger mechanism. The elongate arm portion extends distally from a first handle end of the upper handle portion. The pincher mechanism operably extends distally from the elongate arm portion and is operatively coupled to the trigger mechanism. The trigger mechanism is operable to selectively close the pincher mechanism via the elongate arm portion.

The arm support portion comprises an arm-engaging radiused portion, a central radiused portion, and a handle-engaging radiused portion. The arm-engaging radiused portion, the central radiused portion, and the handle-engaging radiused portion each extend in a respective and differing radiused portion plane. The central radiused portion interconnects the arm-engaging radiused portion and the handle-engaging radiused portion. The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism. The arm support portion thereby counterbalances a load associated with the pincher mechanism.

In some embodiments, the lower handle portion comprises a female support mating portion therewithin. The handle-engaging radiused portion terminates in a tool-engaging end having a male handle mating portion extending therefrom. The male handle mating portion is matable with the female support mating portion. In some embodiments, the female support mating portion is mated with the male handle mating portion such that an internal mating length of the male handle mating portion is greater than an external length of the male handle mating portion.

In some embodiments, the lower handle portion comprises an internal array of rib elements spaced relative to one another along the internal mating length together being configured to define the female support mating portion. The internal array of rib elements is configured to maintain axial alignment of the male handle mating portion relative to the female support mating portion. In some embodiments, the male handle mating portion and the female support mating portion each comprise corresponding fastener-receiving apertures in spaced relation to one another along the internal mating length for receiving fasteners configured to fasten the male handle mating portion to the female support mating portion.

In some embodiments, the arm-engaging radiused portion extends within a radiused arm portion plane obliquely angled relative to the arm axis such that the radiused arm portion plane extends through a grip end of the upper handle portion at a junction thereof with the lower handle portion. In some embodiments, the radiused arm portion plane is obliquely angled between the arm axis and the grip axis. In some embodiments, the arm-engaging radiused portion comprises opposed linear first and second support segments extending from terminal ends of an arc length thereof configured to flank outer portions of the user's forearm equidistantly from the forearm axis.

There is provided in accordance with another aspect of the presently disclosed subject matter a grabber tool for enabling a user to grab objects. The grabber tool comprises a handle mechanism further comprising an upper handle portion, a lower handle portion, and a trigger mechanism. The grabber tool further comprises a tubular member. The tubular member comprises an elongate arm portion, a through-handle portion and an arm support portion. The through-handle portion comprises a radiused handle portion, and the arm support portion has an array of radiused portions, including an arm-engaging radiused portion, a central radiused portion, and a handle-engaging radiused portion.

The grabber tool further comprises a pincher mechanism operably extending distally from the elongate arm portion operatively coupled to the trigger mechanism. The trigger mechanism is operable to selectively close the pincher mechanism via the elongate arm portion. The through-handle portion extends through the handle mechanism such that the radiused handle portion extends through the upper handle portion and the lower handle portion. The arm-engaging radiused portion, the central radiused portion, and the handle-engaging radiused portion each extend in a respective and differing radiused portion plane such that the central radiused portion interconnects the arm-engaging radiused portion and the handle-engaging radiused portion.

The arm support portion is configured to orient a forearm axis of a user's forearm toward the handle mechanism in parallel relation to the upper handle portion. At least the elongate arm portion and the pincher mechanism have a weight directed downwardly such that the arm-engaging radiused portion is directed upwardly toward the user's forearm about a fulcrum point at the handle mechanism, the arm support portion thereby counterbalancing a load associated with the pincher mechanism.

In some embodiments, the arm-engaging radiused portion, the central radiused portion, and the handle-engaging radiused portion each extend through a respective and differing arc length. In some embodiments, the arm-engaging radiused portion extends through a first arc length, the central radiused portion extends through a second arc length, and the handle-engaging radiused portion extends through a third arc length. In some embodiments, the first arc length is greater than both the second and third arc lengths. In some embodiments, the third arc length is greater than the second arc length. In some embodiments, the arm-engaging radiused portion extends within a radiused arm portion plane or first radiused portion plane obliquely angled relative to the elongate arm portion such that the radiused arm portion plane extends through a grip end of the upper handle portion at a junction thereof with the lower handle portion. The radiused arm portion plane being obliquely angled between the elongate arm and the lower handle portion.

Accordingly, although the presently disclosed subject matter has been described by reference to certain embodiments, it is not intended that the grabber tool and novel arm support portion and associated applications and methods be limited thereby, but that modifications thereof are intended to be included as falling within the broad scope and spirit of the foregoing disclosures and the appended drawings. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A grabber tool for enabling a user to grab objects, the grabber tool comprising:
a handle mechanism configured to be ergonomically received in a user's hand, the handle mechanism comprising an upper handle portion, a lower handle portion angled relative to the upper handle portion along a grip axis, and a trigger mechanism extending intermediate the upper handle portion and the lower handle portion configured to enable at least a portion of the user's hand to selectively direct a trigger portion thereof toward the lower handle portion;
an elongate arm portion, the elongate arm portion extending distally from the upper handle portion along an arm axis in coaxial alignment with the upper handle portion, the lower handle portion extending along a grip axis obliquely angled relative to the arm axis at a handle angle;
a pincher mechanism operably extending distally from the elongate arm portion and being operatively coupled to the trigger mechanism, the trigger mechanism being operable to selectively close the pincher mechanism via the elongate arm portion; and
an arm support portion, the arm support portion having an array of radiused portions, including an arm-engaging radiused portion, a central radiused portion, and a handle-engaging radiused portion;
the arm-engaging radiused portion, the central radiused portion, and the handle-engaging radiused portion each extending in a respective and differing radiused portion plane, the central radiused portion interconnecting the arm-engaging radiused portion and the handle-engaging radiused portion;
the arm support portion being configured to orient a forearm axis of a user's forearm toward the handle mechanism in parallel relation to the upper handle portion, at least the elongate arm portion and the pincher mechanism having a weight directed downwardly such that the arm-engaging radiused portion is directed upwardly toward the user's forearm about a fulcrum point at the handle mechanism, the arm support portion thereby counterbalancing a load associated with the pincher mechanism.

2. The grabber tool according to claim 1, wherein the lower handle portion comprises a female support mating portion therewithin, the handle-engaging radiused portion terminating in a tool-engaging end with a male handle mating portion extending therefrom, the male handle mating portion being matable with the female support mating portion.

3. The grabber tool according to claim 2, wherein the female support mating portion is mated with the male handle mating portion such that an internal mating length of the male handle mating portion is greater than an external length of the male handle mating portion.

4. The grabber tool according to claim 3, wherein the lower handle portion comprises an internal array of rib elements spaced relative to one another along the internal mating length together configured to define the female support mating portion, the internal array of rib elements being configured to maintain axial alignment of the male handle mating portion relative to the female support mating portion.

5. The grabber tool according to claim 3, wherein the male handle mating portion and the female support mating portion each comprise corresponding fastener-receiving apertures in spaced relation to one another along the internal mating length for receiving fasteners configured to fasten the male handle mating portion to the female support mating portion.

6. The grabber tool according to claim 1, wherein the arm-engaging radiused portion extends within a radiused arm portion plane obliquely angled relative to the arm axis such that the radiused arm portion plane extends through a grip end of the upper handle portion at a junction thereof with the lower handle portion, the radiused arm portion plane being obliquely angled between the arm axis and the grip axis.

7. The grabber tool according to claim 1, wherein the arm-engaging radiused portion comprises opposed linear first and second support segments extending from terminal ends of an arc length thereof configured to flank outer portions of the user's forearm equidistantly from the forearm axis.

8. The grabber tool according to claim 7, wherein at least a portion of the arm-engaging radiused portion comprises a padded exterior surface for providing a padded interface intermediate the user's forearm and the arm-engaging radiused portion.

9. A grabber tool for enabling a user to grab objects, the grabber tool comprising:
a handle mechanism, the handle mechanism comprising an upper handle portion, a lower handle portion, and a trigger mechanism;
an elongate arm portion, the elongate arm portion extending distally from a first handle end of the upper handle portion;
a pincher mechanism operably extending distally from the elongate arm portion and being operatively coupled to the trigger mechanism, the trigger mechanism being operable to selectively close the pincher mechanism via the elongate arm portion; and
an arm support portion, the arm support portion comprising an arm-engaging radiused portion, a central radiused portion, and a handle-engaging radiused portion, the arm-engaging radiused portion, the central radiused portion, and the handle-engaging radiused portion each extending in a respective and differing radiused portion plane, the central radiused portion interconnecting the arm-engaging radiused portion and the handle-engaging radiused portion;
the arm support portion being configured to orient a forearm axis of a user's forearm toward the handle mechanism in parallel relation to the upper handle portion, at least the elongate arm portion and the pincher mechanism having a weight directed downwardly such that the arm-engaging radiused portion is directed upwardly toward the user's forearm about a fulcrum point at the handle mechanism, the arm support portion thereby counterbalancing a load associated with the pincher mechanism.

10. The grabber tool according to claim 9, wherein the lower handle portion comprises a female support mating portion therewithin, the handle-engaging radiused portion terminating in a tool-engaging end having a male handle mating portion extending therefrom, the male handle mating portion being matable with the female support mating portion.

11. The grabber tool according to claim 10, wherein the female support mating portion is mated with the male handle mating portion such that an internal mating length of the male handle mating portion is greater than an external length of the male handle mating portion.

12. The grabber tool according to claim 11, wherein the lower handle portion comprises an internal array of rib elements spaced relative to one another along the internal mating length together being configured to define the female support mating portion, the internal array of rib elements being configured to maintain axial alignment of the male handle mating portion relative to the female support mating portion.

13. The grabber tool according to claim 11, wherein the male handle mating portion and the female support mating portion each comprise corresponding fastener-receiving apertures in spaced relation to one another along the internal mating length for receiving fasteners configured to fasten the male handle mating portion to the female support mating portion.

14. The grabber tool according to claim 9, wherein the arm-engaging radiused portion extends within a radiused arm portion plane obliquely angled relative to the arm axis such that the radiused arm portion plane extends through a grip end of the upper handle portion at a junction thereof with the lower handle portion, the radiused arm portion plane being obliquely angled between the arm axis and the grip axis.

15. The grabber tool according to claim 9, wherein the arm-engaging radiused portion comprises opposed linear first and second support segments extending from terminal ends of an arc length thereof configured to flank outer portions of the user's forearm equidistantly from the forearm axis.

16. A grabber tool for enabling a user to grab objects, the grabber tool comprising:
a handle mechanism, the handle mechanism comprising an upper handle portion, a lower handle portion, and a trigger mechanism;
a tubular member, the tubular member comprising an elongate arm portion, a through-handle portion and an arm support portion, the through-handle portion comprising a radiused handle portion, the arm support portion having an array of radiused portions, including an arm-engaging radiused portion, a central radiused portion, and a handle-engaging radiused portion; and
a pincher mechanism operably extending distally from the elongate arm portion and being operatively coupled to the trigger mechanism, the trigger mechanism being operable to selectively close the pincher mechanism via the elongate arm portion;
the through-handle portion extending through the handle mechanism such that the radiused handle portion extends from the upper handle portion to the lower handle portion;
the arm-engaging radiused portion, the central radiused portion, and the handle-engaging radiused portion each extending in a respective and differing radiused portion plane, the central radiused portion interconnecting the arm-engaging radiused portion and the handle-engaging radiused portion;
the arm support portion being configured to orient a forearm axis of a user's forearm toward the handle mechanism in parallel relation to the upper handle portion, at least the elongate arm portion and the pincher mechanism having a weight directed downwardly such that the arm-engaging radiused portion is directed upwardly toward the user's forearm about a fulcrum point at the handle mechanism, the arm support portion thereby counterbalancing a load associated with the pincher mechanism.

17. The grabber tool according to claim 16, wherein the arm-engaging radiused portion, the central radiused portion, and the handle-engaging radiused portion each extend through a respective and differing arc length.

18. The grabber tool according to claim 17, wherein the arm-engaging radiused portion extends through a first arc length, the central radiused portion extends through a second arc length, and the handle-engaging radiused portion extends through a third arc length, the first arc length being greater than both the second and third arc lengths.

19. The grabber tool according to claim 18, wherein the third arc length is greater than the second arc length.

20. The grabber tool according to claim 16, wherein the arm-engaging radiused portion extends within a radiused arm portion plane obliquely angled relative to the elongate arm portion such that the radiused arm portion plane extends through a grip end of the upper handle portion at a junction thereof with the lower handle portion, the radiused arm portion plane being obliquely angled between the elongate arm portion and the lower handle portion.
